(19) United States
(12) Patent Application Publication
(10) Pub. No.: US 2010/0053970 A1
(43) Pub. Date: Mar. 4, 2010

(54) LIGHT-EMITTING DEVICE AND ILLUMINATING DEVICE

(75) Inventors: Takahiro Sato, Kanagawa-ken (JP); Shinji Saito, Kanagawa-ken (JP); Shinya Nunoue, Chiba-ken (JP); Yasushi Hattori, Kanagawa-ken (JP); Maki Sugai, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/411,912

(22) Filed: Mar. 26, 2009

(30) Foreign Application Priority Data
Aug. 29, 2008 (JP) 2008-221592

(51) Int. Cl. G02B 27/20; G02F 1/35

(52) U.S. Cl. 362/259; 359/326

(57) ABSTRACT

A light-emitting device includes: a first laser light source; a first diffusion member provided along a light axis of a first light radiated form the first laser light source; and a first wavelength converter provided along the first diffusion member. The first diffusion member generates a second light from the first light. The second light outgoes in a direction different from the light axis direction of the first light. A ratio of generating the second light from the first light in a first part is higher than that in a second part, wherein an intensity of the first light in the first part is lower than that in a second part. The first wavelength converter absorbs the second light and emitting a third light having a different wavelength from the second light.

### CROSS-REFERENCE TO RELATED APPLICATIONS

This application is based upon and claims the benefit of priority from the prior Japanese Patent Application No. 2008-221592, filed on Aug. 29, 2008; the entire contents of which are incorporated herein by reference.

### BACKGROUND OF THE INVENTION

This invention relates to a light-emitting device and an illuminating device.

### BACKGROUND ART

A Light emitting device having, for example, a plane shape or a line shape and generating, for example, white light by using a light-emitting element such as LED (Light Emitting Diode) has been developed, and is applied to, for example, back light of a liquid crystal display apparatus, or the like.

By contrast, if a light emitting device having a line shape or a rod shape, for example, a shape such as a fluorescent lamp can be realized from a light source having a small area by a laser light-emitting element, a higher efficient illuminating device can be realized.

However, in the laser light-emitting element, the light radiated from the laser light-emitting element has a single wavelength, and has strong directivity, and therefore, special ingenuity is required for application to the light-emitting device having a large area and generating, for example, white light. That is, a technique in which laser light output with a thin light flux is output evenly in the different direction from the axis of the light flux and converted into light having wavelength over the wavelength range of the visual light is required.

In Patent document (JP-A 2006-73202(Kokai)), a technique is disclosed for a light-emitting device by which laser light of blue light and red light are input to a light guide plate and white light is output from a fluorescent material provided in a light-extracting surface of the light guide plate. However, in this method, because the light having different wavelengths is used as the light source, unevenness of the color is caused while the light is propagated through the light guide plate.

That is, the light such as white light in which components having different wavelengths are synthesized causes unevenness of the color while transmitted through a long distance because reflection and absorption characteristics of each of the wavelengths are different. Furthermore, ejection loss of energy is caused by absorption.

### SUMMARY OF THE INVENTION

According to an aspect of the invention, there is provided a light-emitting device including: a first laser light source radiating a first light having a light axis; a first diffusion member provided along the light axis of the first light, the first diffusion member receiving the first light and generating a second light from the first light, the second light outgoing in a direction different from a direction of the light axis of the first light, the first diffusion member having a first part and a second part, an intensity of the first light in the first part being lower than that in the second part, a ratio of generating the second light from the first light in the first part being higher than that in the second part; and a first wavelength converter provided along the first diffusion member, the first wavelength converter absorbing the second light and emitting a third light having a different wavelength from the second light.

According to another aspect of the invention, there is provided an illuminating device including: a light-emitting device including: a first laser light source radiating a first light having a light axis; a first diffusion member provided along the light axis of the first light, the first diffusion member receiving the first light and generating a second light from the first light, the second light outgoing in a different direction from a direction of the light axis of the first light, the first diffusion member having a first part and a second part, an intensity of the first light in the first part being lower than that in the second part, a ratio of generating the second light from the first light in the first part being higher than that in the second part; and a first wavelength converter provided along the first diffusion member, the first wavelength converter absorbing the second light and emitting a third light having a different wavelength from the second light; and a current supplier being configured to supply a current to the first laser light source of the light-emitting device

### BRIEF DESCRIPTION OF THE DRAWINGS

FIGS. 1A to 1C are schematic views illustrating the configuration of a light-emitting device according to a first embodiment of the invention;

FIGS. 2A and 2B are schematic views illustrating the configuration of a member used in the light-emitting device according to the first embodiment of the invention;

FIGS. 3A to 3D are graphs illustrating characteristics of the diffusion member used in the light-emitting device according to the first embodiment of the invention;

FIG. 4 is a schematic perspective view illustrating the configuration of a diffusion member used in a light-emitting device according to a second embodiment of the invention;

FIGS. 5A and 5B are graphs illustrating characteristics of the diffusion member used in the light-emitting device according to the second embodiment of the invention;

FIG. 6 is a schematic perspective view illustrating the configuration of a diffusion member used in a light-emitting device according to a third embodiment of the invention;

FIGS. 7A and 7B are graphs illustrating characteristics of the diffusion member used in the light-emitting device according to the third embodiment of the invention;

FIG. 8 is a schematic perspective view illustrating the configuration of a diffusion member used in a light-emitting device according to a fourth embodiment of the invention;

FIGS. 9A to 9D are graphs illustrating characteristics of the diffusion member used in the light-emitting device according to the fourth embodiment of the invention;

FIG. 10 is a schematic perspective view illustrating the configuration of a diffusion member used in a light-emitting device according to a fifth embodiment of the invention;

FIGS. 11A and 11B are schematic perspective views illustrating the configuration of a diffusion member used in a light-emitting device according to a sixth embodiment of the invention;

FIGS. 12A and 12B are schematic perspective views illustrating the configuration of a diffusion member and a wavelength-converter used in a light-emitting device according to a seventh embodiment of the invention;

FIGS. 13A and 13B are schematic perspective views illustrating the configuration of a light-emitting device according to an eighth embodiment of the invention;

FIGS. 14A to 14C are schematic views illustrating the configuration of a light-emitting device according to a ninth embodiment of the invention;

FIGS. 15A and 15B are graphs illustrating characteristics of the diffusion member used in the light-emitting device according to the ninth embodiment of the invention;

FIGS. 16A to 16C are schematic views illustrating characteristics of the light-emitting device according to the ninth embodiment of the invention;

FIGS. 17A and 17B are schematic views illustrating the configuration of a diffusion member used in a light-emitting device according to a tenth embodiment of the invention;

FIG. 18 is a schematic view illustrating the configuration of a light-emitting device according to an eleventh embodiment of the invention;

FIGS. 19A to 19C are schematic views illustrating the configuration of a light-emitting device according to an twelfth embodiment of the invention;

FIGS. 20A to 20C are schematic views illustrating the configuration of a light-emitting device according to an thirteenth embodiment of the invention;

FIG. 21 is a schematic plan view illustrating the configuration of a light-emitting device according to a fourteenth embodiment of the invention;

FIGS. 22A to 22C are schematic plan views illustrating the configuration of a light-emitting device according to a fifteenth embodiment of the invention; and

FIG. 23 is a schematic view illustrating the configuration of an illuminating device according to a sixteenth embodiment of the invention.

### DETAILED DESCRIPTION OF THE INVENTION

Hereinafter, embodiments of the invention will be described with reference to drawings.

The drawings are schematic or conceptual. And, relation of thickness and width of each of components, specific coefficient of scales of members, and so forth are not necessarily the same as the actual ones. Moreover, even when the same parts are shown, the scales or specific coefficients are occasionally shown to be different from each other in some drawings.

Moreover, in the specification and each of the drawings, the same reference numerals will be appended to the same elements as those described with respect to a previously presented figure, and the detailed description thereof will be appropriately omitted.

### First Embodiment

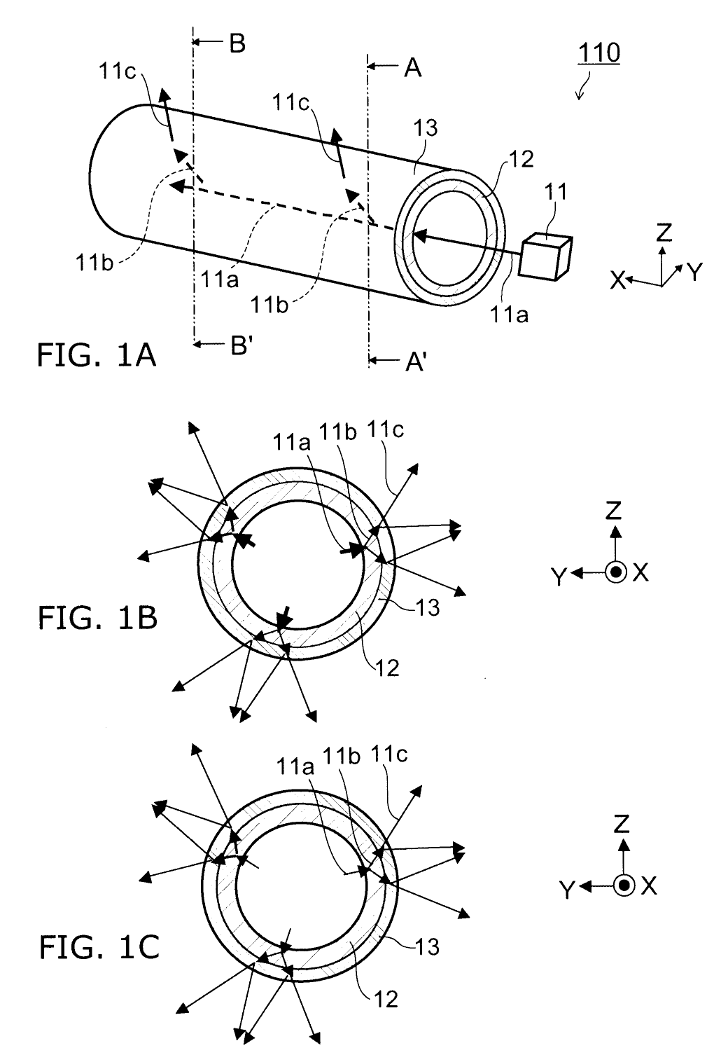

FIGS. 1A to 1C are schematic views illustrating the configuration of a light-emitting device according to a first embodiment of the invention.

That is, FIG. 1A is a schematic perspective view, and FIG. 1B is a cross-sectional view taken along line A-A′ of FIG. 1A, and FIG. 1C is a cross-sectional view taken along line B-B′.

As shown in FIG. 1A, the light-emitting device 110 according to the first embodiment of the invention includes a first laser light source 11, a first diffusion member 12 provided along a light axis of a first light 11a radiated from the first laser light source 11 and generating from the first light 11a a second light 11b outgoing in different directions from the light axis direction of the first light 11a, and a first wavelength-converter 13 provided along the first diffusion member 12, absorbing the second light 11b and emitting a third light having a different wavelength from the second light 11b.

And, in the first diffusion member 12, the ratio of generating the second light 11b from the first light 11a is set to be higher in the part in which the intensity of the first light 11a is low than in the part in which the intensity is high. For example, in the first diffusion member 12, the ratio of generating the second light 11b from the first light 11a is set to be higher at the far position from the laser light source than at the near potion thereto.

Here, as shown in FIG. 1A to 1C, the light axis direction of the first light 11a output from the first laser light source 11 is set to be an X axis direction. And a perpendicular direction to X axis is set to be Y axis, and the perpendicular direction to X axis and Y axis is set to be Z axis. And, the original point that is the intersection point of X axis, Y axis, and Z axis is set to be the central point of brightness of the first light 11a.

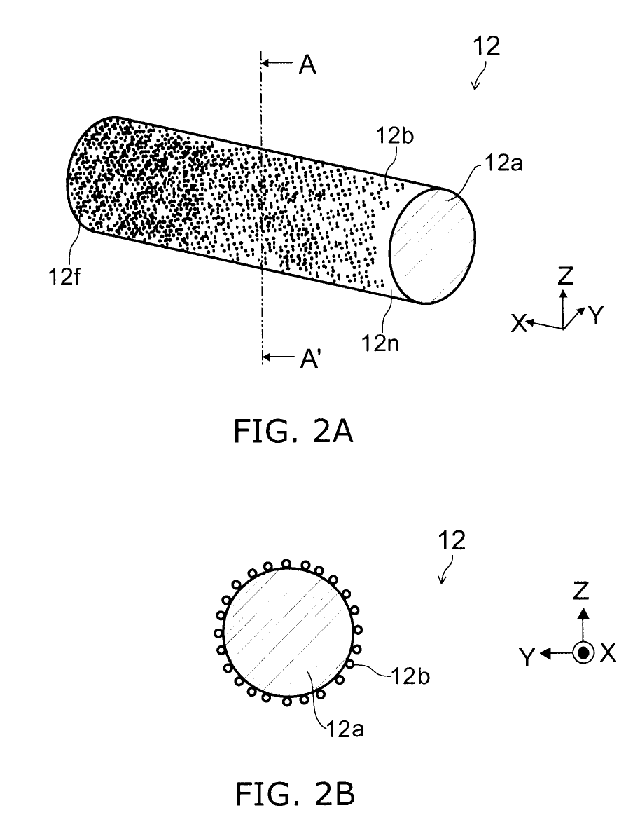

FIGS. 2A and 2B are schematic views illustrating the configuration of a diffusion member used in the light-emitting device according to the first embodiment of the invention.

That is, FIG. 2A is a schematic perspective view, and FIG. 2B is a cross-sectional view taken along line A-A′ of FIG. 2A.

As shown in FIGS. 2A and 2B, for the first diffusion member 12, for example, a rod-shaped structure 12a of glass or resin having a columnar shape can be used. However, as described later, the invention is not limited thereto, but the first diffusion member 12 can be made of various structures and materials. Hereinafter, for the explanation, first, the case in which the first diffusion member 12 has the rod-shaped structure 12a will be described.

In the first diffusion member 12, on a wall of the rod-shaped structure 12a, for example, as diffusion bodies 12b, microparticles causing scattering are provided by, for example, an application method.

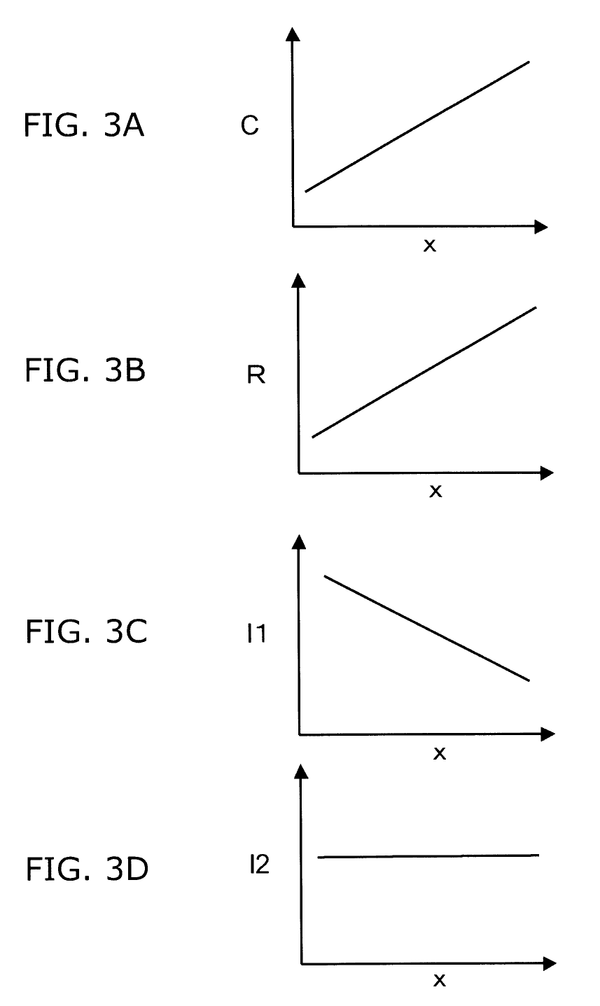

FIGS. 3A to 3D are graphic views illustrating characteristics of the diffusion member used in the light-emitting device according to the first embodiment of the invention.

That is, the vertical axis of FIG. 3A represents density C of the diffusion bodies 12b. The vertical axis of FIG. 3B represents a ratio of generating the second light 11b with respect to the first light 11a, namely, a diffusion degree R. The vertical axis of FIG. 3C represents intensity I1 of the first light 11a. The vertical axis of FIG. 3D represents intensity I2 of the second light 11b. And, the horizontal axes of FIGS. 3A to 3D represent distance x in the X-axis direction. Hereinafter, for the density C, number density of the diffusion bodies 12b per micro-space volume of the first diffusion member 12 in the case where the diffusion bodies 12b is based on particles whose material, particle diameter, and shape are uniform to a certain extent will be representatively described. For the diffusion bodies 12b, it can be thought that if the particle diameter and the shape are the same, as the number density increases, the diffusion degree R increases, and if the number density and the shape are the same, as the volume density increases, the diffusion degree R increases, and if the number density and the particle diameter are the same, as the total surface area thereof increases, the diffusion degree R basically increases. Actually, the diffusion bodies 12b are frequently an aggregation of particles whose particle diameters and shapes are different, and the density C only needs to be considered as the sum of the number density and the volume density and the effect of the total surface area.

As shown in FIG. 3A, the density C of the diffusion bodies 12b is larger as the distance x is larger.

Thereby, as shown in FIG. 3B, the ratio of generating the second light 11b with respect to the first light 11a, namely the diffusion degree R increases as the distance x is larger.

On the other hand, some component of the first light 11a output from the first laser light source 11 is extracted as the second light 11b by the first diffusion member 12, and therefore, as shown in FIG. 3C, the intensity I1 of the first light 11a decreases as the distance x is larger.

The characteristics illustrated in FIGS. 3B and 3C are compensated each other.

As a result, as shown in FIG. 3D, the intensity I2 of the second light 11b becomes constant, independently of the distance x.

And, as shown in FIG. 1B and 1C, the optical characteristics of the first diffusion member 12 is adjusted, and thereby the second light 11b whose intensity is uniformized over the X axis direction is input to the first wavelength-converter 13, and a third light 11c having a different wavelength from the second light 11b is generated. In this case, because the intensity of the second light 11b is uniform, the intensity of the third light 11c becomes substantially uniform independent of position from the first laser light source 11.

In this case, the first wavelength-converter 13 can absorb the second light 11b and emit the third light 11c having the various wavelengths of the visible light. For example, the first wavelength-converter 13 can include different types of fluorescent materials absorbing the second light 11b and emitting different wavelengths, and thereby, the light having a desired color can be emitted. That is, as the third light 11c, white light can be emitted.

As described above, independent of the distance from the first laser light source 11, the light having constant intensity and color, for example, white light can be generated. The white light is light outgoing in, for example, the perpendicular direction to the light axis of the first light 11c from the first laser light source 11.

As described above, in the light-emitting device 110 according to the first embodiment, a uniform light can be radiated from the side surface of a rod-shaped structure, such as a conventional fluorescent lamp, and the light-emitting device with lower power consumption, higher reliability, and longer operating life compared with a conventional fluorescent lamp can be realized.

In the light-emitting device 110 according to this embodiment, the first laser light source 11 with a single wavelength is used as the light source.

By contrast, like a technique disclosed in, for example, JP-A 2006-73202(Kokai), in the case that the laser light of blue light and red light are input into the light guide plate and white light is output by a fluorescent material provided on the light-extracting surface of the light guide plate, because the light having different wavelengths are used as the light source, unevenness of color is caused while the light is transmitted through the light guide plate. That is, because light having a long wavelength more easily passes through the light guide plate than light having a short wavelength, the wavelength distribution of light changes between the near side to and the far side from the light source. If such light is attempted to be converted into white light by a fluorescent material, the color changes depending on the distance from the light source, and a problem is caused. It realistically involves large difficulty to adjust the wavelength distribution of the optical characteristics of the first diffusion member 12 in accordance with this change of the wavelength distribution.

That is, in the white light, two or more kinds of light having different wavelength regions from the blue component to the red component are synthesized. Because the light having the respective wavelengths have different transmittances, refractive indices, and visibilities, when the white light proceeds long inside the light guide body or when the white light repeats reflection or scattering and light path length thereof is substantially long, unevenness of light is caused. Specifically, when the white light proceeds inside the guide light body giving lower transmittance to blue light than to yellow light, as the light proceeds, the light changes to be yellowish white.

By contrast, in the light-emitting device 110 according to this embodiment, the first laser light source 11 with a single wavelength is used as the light source. Thereby, even if intensity of the first light 11a changes by the distance from the laser light source 11, the wavelength distribution does not substantially change. Therefore, the wavelength distribution of the second light 11b is also constant. Therefore, change of the intensity of the first light 11a is adjusted by adjusting the diffusion degree (the ratio of generating the second light 11b from the first light 11a) of the first diffusion member 12, and thereby, the intensity of the second light 11b is uniformized, and as a result, the third light 11c having uniform intensity and color can be generated.

Like one application of this embodiment, in a light-emitting body having a rod shape for which illumination such as fluorescent lamp is assumed, uniform light irradiation is performed to the entire circumference of the rod shape, and furthermore, the brightness is uniformized in the longitudinal direction of the rod shape. Therefore, the light-emitting device 110 according to this embodiment is different from a device having a purpose of light irradiation in a certain special direction of the plate such as a general light guide plate or a light-emitting device for a back light and different from the device in which it is assumed to further secondarily use a light diffusion plate as well as a light guide plate, and the characteristics of the first diffusion member 12 are different from those of these light-emitting devices.

That is, in the light-emitting device 110 according to this embodiment, a laser light source is used as the light source. This light source has a characteristic that the light is generated in the extremely narrow direction with a high output from the point light source, and is different from a surface light source such as a fluorescent lamp and a cold-cathode tube or from the case where the light is output to a wide range from a point light source such as LED. In the light-emitting device 110 according to this embodiment, the characteristics of the first diffusion member 12 are designed according to the light characteristics from the laser light source. That is, the first diffusion member 12 has particular characteristics for evenly diffusing light of a narrow range into a wide range.

In FIGS. 3A to 3D, the relations between the distance x and the density C, the diffusion degree R, the intensity I1, and the intensity I2 of the diffusion bodies 12b are schematically illustrated, and the relations between the distance x and the density C, the diffusion degree R, the intensity I1, and the intensity I2 of the diffusion bodies 12b are shown as linear functions, but the invention is not limited thereto. That is, various modifications of the relations between the distance x and the density C, the diffusion degree R, and the intensity I1 of the diffusion bodies 122b like downward-convex curves or upward-convex curves, curves having inflection points are possible.

In the light-emitting device 110 according to this embodiment, for the first laser light source 11, for example, a semiconductor laser light-emitting element can be used. In this case, for obtaining white light as the third light 11c by exciting the fluorescent material of the first wavelength-converter 13, the semiconductor laser light-emitting element with wavelength from the ultraviolet region to the blue region is preferable. And, considering high output and high energy conversion efficiency, a semiconductor laser light-emitting element in which nitride semiconductor such as GaN is used is particularly preferable.

And, it is further desirable that a semiconductor laser light-emitting device having emission in the violet-blue region to the blue region that does not emit the ultraviolet light is used.

That is, the emission wavelength of the first laser light source 11 can have a peak at an emission wavelength in 380 nm to 480 nm.

And, in the first laser light source 11, intensity of the light of 350 nm or less can be substantially zero.

That is, a semiconductor laser light-emitting element whose intensity of the light of 350 nm or less is almost zero and which has an emission peak wavelength can be used.

As the semiconductor laser light-emitting element, there can be used a gallium nitride compound semiconductor device (for example, JP 3488597) including a single crystal substrate and a stacked film having a plurality of layers composed basically of (InₓGa_{y}Al_{z}N, x+y+z=1, 0≦x, y, z≦1) formed on the single crystal substrate, in which the stacked film has a double heterojunction structure including an n-clad layer, an active layer formed on the n-clad layer, and a p-clad layer formed on the active layer, and a heat-generating structure including a high-resistance part formed on the p-clad layer and having a relatively low concentration of p-type impurity, and two low-resistance parts having a relatively high concentration of p-type impurity that are located so as to sandwich the high-resistance part.

For the rod-shaped structure 12a used in the first diffusion member 12, for example, glass having transparency can be used. As described above, transparent and colorless materials among metal multiple oxides as represented by glass are particularly preferable for the material used for the rod-shaped structure 12a.

On part of the side surface of such a rod-shaped structure 12a, for example, diffusion bodies 12b are provided so that the second light 11b outgoing in different directions from the axis direction of the first light 11a is generated from the first light 11a.

That is, for example, on the wall surface or in the wall of the rod-shaped structure 12a such as glass, the diffusion bodies 12b are provided.

For the diffusion bodies, solid particles can be used. However, the invention is not limited thereto. For example, for the diffusion body 12b, gaseous particles, liquid-formed particles (such as mist), micro-convexoconcave, micro-space, micro-interface having refraction index difference, and so forth can be used. For the magnitude of these particles, micro-convexoconcave, micro-space, or micro-interface, the molecular level to a small piece of millimeter order can be selected according to the required characteristics. Moreover, two or more kinds of diffusion bodies can be used together as needed.

For the diffusion bodies 12b, as a material having high durability and high light reflectance, stable and colorless or white, for example, solid material among metal, metal oxide, nitride, various salts, and so forth can be used.

Specifically, for the diffusion bodies, colorless or white metal oxides such as 12b, Al₂I₃, MgO, MoO₃, SiO₂, SnO₂, Ta₂O₃, TiO₂, WO₃, Y₂O₃, ZnO, and ZrO₂, various glasses, various metal hydroxides such as Ca(OH)₂, various multiple oxides such as zeolite and tungstosilicate, halides such as NaCl and KCl, sulfates such as BaSO₄, diamond powder, and so forth can be used.

As described above, the diffusion bodies can be colorless.

And, the diffusion bodies 12b do not substantially absorb the first light 11a output from the first laser light source 11. And, the diffusion bodies 12b do not absorb the first light 11a but output the second light 11b in the different directions from the light axis of the first light 11a.

For the first wavelength-converter 13, various fluorescent materials can be used. For example, the outgoing light (third light 11c) of the light-emitting device 110 can be a desired color, for example, white, and for adjustment of the various colors, a plurality of fluorescent materials can be used. For at least part of the fluorescent materials used in the first wavelength-converter 13, a fluorescent material being capable of converting wavelength of the light in the wavelength region of the second light 11b whose pathway is converted from the first light 11a can be used.

That is, the first wavelength-converter 13 includes a fluorescent material.

And, the first wavelength-converter 13 can include a plurality of kinds of fluorescent materials having different emission wavelengths. That is, the first wavelength-converter 13 can include a first fluorescent material absorbing the second light 11b and emitting light with a first wavelength different from the second light 11b and a second fluorescent material absorbing the second light 11b and emitting light with a second wavelength different from the second light 11b and different from the first wavelength.

The first wavelength-converter 13 is placed around the first diffusion member 12. For example, a fluorescent material serving as the first wavelength-converter 13 can be attached to the surrounding of the rod-shaped structure 12a serving as the first diffusion member 12. Moreover, around the rod-shaped structure 12a, the fluorescent material serving as the first wavelength-converter 13 may be applied, or the fluorescent material layer may be attached by using adhesive. As described above, the first wavelength-converter 13 can be provided to be in contact with the first diffusion member 12. Furthermore, the first wavelength-converter 13 and the rod-shaped structure 12a serving as the first diffusion member 12 may be disposed separately.

In the first wavelength-converter 13, the fluorescent material may be used singly, and the fluorescent material may be used with being dispersed into a matrix such as solvent or resin, and the fluorescent material that is single or dispersed may be molded into sheet shape, hemispherical shape, or plate shape.

The first laser light source 11, the first diffusion member 12, and the first wavelength-converter 13 can be disposed so that solid or liquid serving as the first diffusion member 12 or the first wavelength-converter 13 is not in contact with the end face of the first laser light source 11. Thereby, bad influence to the laser oscillation generated when a foreign material contacts the end face of the first laser light source 11, heat generation from high energy light or the light-emitting element, and degradation of the material used as the first diffusion member 12 or the first wavelength-converter 13 can be suppressed. However, the invention is not limited thereto. The first diffusion member 12 or the first wavelength-converter 13 may be in contact with the end surface of the first laser light source 11.

The first diffusion member 12 is provided along the light axis (X axis direction) of the first light 11a radiated from the first laser light source 11. However, in this case, a central axis of the first diffusion member 12 can be placed so as to accord with a central axis (axis of the part in which the light strength is the highest) of the first light 11a. Thereby, because bias of the first light 11a in the first diffusion member 12 is small, the diffusion control becomes easily performed.

However, the invention is not limited thereto, and it is possible that the central axis of the first diffusion member 12 and the central axis of the first light 11a do not accord. For example, according to various conditions in which the light-emitting device is provided, for example, such as various conditions when the light-emitting device is fixed to a wall or a ceiling, the central axis of the first diffusion member 12 and the central axis of the first light 11a may be displaced. In this case, the emitting light (third light 11c) from the light-emitting device can be provided with brightness distribution having anisotropy around X axis, and for example, it can be designed so that the brightness becomes low in the back side provided with the light-emitting device and that the brightness becomes high in the front side thereof.

Moreover, in the case where the central axis of the first diffusion member 12 and the central axis of the first light 11a are displaced, uniform brightness distribution can also be provided around X axis by adjusting density of the diffusion bodies 12b in the first diffusion bodies according to the displacement of the axis.

The fixing place and fixing method of the first wavelength-converter 13 and the first diffusion member 12 are appropriately determined on the basis of configurations or characteristics of the first diffusion member 12 and the light-emitting device 110.

The used material or configuration of the diffusion bodies 12b is appropriately determined considering characteristics such as light absorptance, light reflectance, intensity of light scattering, long-term stability for light, and long-term stability for heat.

As the first laser light source 11, as well as the case that a semiconductor laser light-emitting element with a single wavelength is used singly, the case where the configuration of using a plurality of kinds of semiconductor laser light-emitting elements with wavelengths of various colors, for example, the configuration of using semiconductor laser light-emitting elements with colors such as green, yellow, orange, and red for compensating the white components in combination is used is not preferable because when two or more elements with different oscillation wavelengths are used, driving voltages are also different and therefore two or more kinds of electric control circuits becomes required.

Therefore, it is desirable that white is produced by the combination of one kind of the semiconductor laser light-emitting element having a peak at an emission wavelength in the ultraviolet region to the blue region and a fluorescent material having a peak at an emission wavelength in the longer wavelength.

If a material converting the wavelength like a fluorescent material with respect to the wavelength region of the light generated from the semiconductor laser light-emitting element is also used as the diffusion bodies 12b, unevenness of color is caused as described above, and therefore, for example, the configuration that the optical characteristics of the first wavelength-converter 13 is controlled to illustratively change the amount or the mixture ratio of the fluorescent material and thereby the unevenness of color is compensated can be thought. However, because the fluorescent material having 100% quantum efficiency is not realistic and loss of the light is inevitably caused by clash of the light to the fluorescent material, it is not preferable to use a fluorescent material as the diffusion bodies 12b.

The shape of the diffusion member 12 is optional. That is, in FIGS. 1A to 2B, the case where columnar rod-shaped structure 12a is used as the first diffusion member 12 is illustrated, but the invention is not limited thereto. The shape of the first diffusion member 12 can be various shapes based on design or functionality of, for example, the light-emitting device, illuminating device using it, and the space in which they are placed.

In the rod-shaped structure 12a used for the first diffusion member 12, slight coloration by a small amount of impurities or impure ions occasionally influences the light transmittance, and by making consideration so that the purity is held in the manufacturing process, the slight coloration by a small amount of impurities or impure ions can be suppressed. For holding the purity, use of clean room, use of purified water, and use of substance of high purity can be employed.

According to a length (length of X axis direction) of the rod-shaped structure, the material used for the rod-shaped structure 12a can be selected by noticing its light transmittance. As the light transmittance is lower, loss of the light is larger before the first light 11a generated from the first laser light source 11 reaches the end of the rod-shaped structure 12a, and the emission efficiency of the light-emitting device 110 becomes lower. Moreover, when the loss of the light transmittance is caused by the absorption of the material of the rod-shaped structure 12a, part or all of the absorbed energy of the light changed to heat energy, and by heat generation or temperature rising of the light-emitting device 110, the emission efficiency of the first wavelength-converter 13 is lowered, and the member of the light-emitting device can be degraded. Therefore, it is desirable that the light transmittance of the rod-shaped structure 12a serving as the first diffusion member 12 is high.

The light transmittance of the rod-shaped structure 12a will be described below. Tentatively, the need criterion of the loss of the light when the light path length is equal to the linear distance with a length of the rod-shaped structure 12a is set to be 10% or less. That is, the light transmittance in this length is set to be 90% or more. For example, when the length of the rod-shaped structure 12a is 100 mm, the 100th power of the light transmittance x per millimeter is 90% or more, and therefore, x becomes 99.9% or more. When the length is 1 m, the value of x whose the 1000th power is 90% or more becomes 99.99% or more. As described above, the required light transmittance of the material can be appropriately estimated. The transmittance per millimeter of the material of the rod-shaped structure 12a can be obtained by measuring the transmittance of the thickness-measured material in the desired wavelength by an ultraviolet-visible spectrometer and converting the transmittance into the transmittance per millimeter.

In general, the light transmittance is lower in the shorter wavelength side. In general, in an organic resin used in the light guide plate or the like, the loss is small in the wavelength of the infrared region used for communication or the like. Therefore, an organic resin is used as the material of the rod-shaped structure 12a used for the first diffusion member 12 of the light-emitting device 110 according to this embodiment, and if the light transmittance thereof is low, the configuration of the rod-shaped structure 12a, the diffusion bodies 12b, and the structure of the first wavelength-converter 13 can be designed according to the light transmittance.

On the other hand, in the diffusion bodies 12b, for suppressing loss of the light and heat generation thereby, at least the light absorptance with respect to the wavelength region of the first light 11a can be set to be small.

Because the diffusion bodies 12b is irradiated with the first light 11a of high energy density, a material stable for a long period with respect to the wavelength region of the first light 11a can be used for the diffusion bodies 12b. Moreover, because there is heat generation from the first laser light source 11, diffusion bodies 12b, the first wavelength-converter 13 and so forth, the material used for the diffusion bodies 12b is appropriately selected considering the heat-resistance.

The material used for the diffusion bodies 12b can be selected in the viewpoint of regulation of the light reflectance or the light scattering intensity.

For the method for providing the diffusion bodies 12b in the first diffusion member 12, various methods can be used.

For example, the rod-shaped structure 12a is used for the first diffusion member 12, and if solid diffusion bodies 12b are used, a required amount of the diffusion bodies 12b can be added to the material of the rod-shaped structure 12a. And, the additive amount of the diffusion bodies 12b and the material or particle diameters of the diffusion bodies are controlled to be required. Moreover, the diffusion bodies 12b may be applied onto the surface of the rod-shaped structure 12a.

For providing density or particle diameter of the diffusion bodies 12b with distribution, all or part of the rod-shaped structure 12a is molded and then the diffusion bodies can be provided by a method such as addition or application so that density, particle diameter, type, or the like of the diffusion bodies changes for each of the positions on the rod-shaped structure.

A method for fabricating various components provided with the diffusion bodies 12b and combining the components to form part or all of the rod-shaped structure 12a can be used.

When the rod-shaped structure 12a is used for the first diffusion member 12 and, for example, bubbles (namely micro-spaces) in the rod-shaped structure 12a are used as the diffusion bodies, the rod-shaped structure 12a is molded so that the bubbles are formed, and thereby, the diffusion bodies 12b can be provided in the rod-shaped structure 12a.

When the rod-shaped structure 12a is used for the first diffusion member 12 and, for example, cracks (namely, micro-interfaces with refraction index difference) in the rod-shaped structure 12a are used as the diffusion bodies, the rod-shape structure 12a is molded so that the cracks are formed, and thereby, the diffusion bodies 12b can be provided in the rod-shaped structure 12a.

It is also possible that a solvent with flowability such as liquid or gas is used as the first diffusion member 12 and the diffusion bodies 12b are disposed therein. In this case, for example, by providing partitions for each of the components, the distribution of the diffusion bodies 12b can be held. Also, a method for fabricating closed components and combining the components can be adopted. For the partitions, colorless and transparent glass plates can be thought, and the invention is not limited thereto, and various methods may be used.

The shape of the diffusion bodies 12b is not particularly limited, but generally, it is desirable that there is no anisotropy. Approximately spherical shape or particle shape near to approximately cubic shape can be used. Moreover, the diffusion bodies 12b having anisotropy may be used. In this case, by arranging the diffusion bodies having anisotropy in a predetermined direction, the intensity of the emitting light can also be improved totally, and the emitting light can also be provided with directivity.

### Second Embodiment

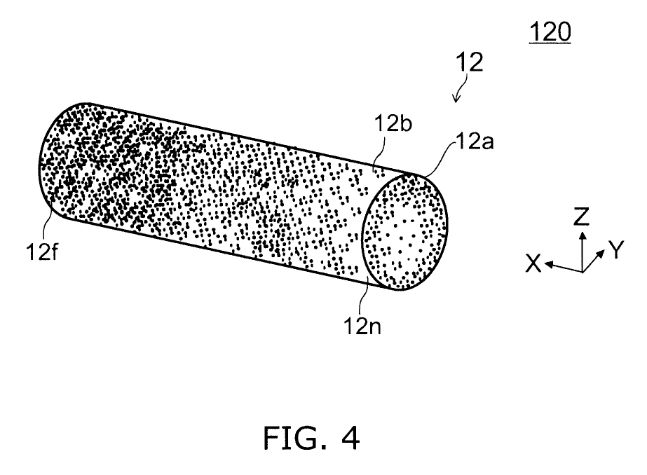

FIG. 4 is a schematic perspective view illustrating the configuration of a diffusion member used in the light-emitting device according to a second embodiment of the invention.

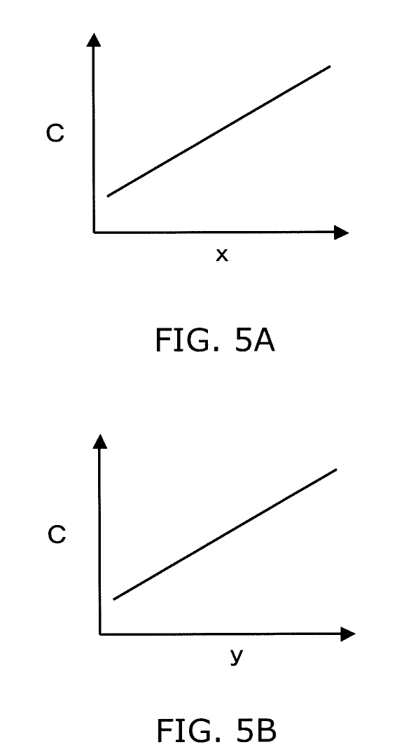

FIGS. 5A and 5B are graphs illustrating characteristics of a diffusion member used in the light-emitting device according to the second embodiment of the invention.

That is, the vertical axis of FIGS. 5A and 5B represents density C of the diffusion bodies 12b. And, the horizontal axis of the FIG. 5A represents distance x in the X axis direction, and the horizontal axis of FIG. 5B represents distance y in the Y axis direction. The horizontal axis of FIG. 5B may be distance z in the Z axis direction.

The light-emitting device 120 according to the second embodiment has characteristics in the first diffusion member 12, and thus, the first diffusion member 12 will be described.

As shown in FIG. 4, in the light-emitting device 120 according to the second embodiment, the first diffusion member 12 has, for example, the translucent columnar rod-shaped structure 12a, and the diffusion bodies 12b are provided in the rod-shaped structure 12a. Other than this configuration, the light-emitting device 120 can be the same as the light-emitting device 110, and thus, the description thereof will be omitted.

And, as shown in FIG. 5A, the density C of the diffusion bodies 12b is larger as the distance x is larger. That is, the density of the diffusion bodies 12b is set to be higher at the front end 12f side of the first diffusion member 12 than at the inlet end 12n of the first diffusion member 12.

And, as shown in FIG. 5B, the density C of the diffusion bodies 12b is larger as the distance y is larger. That is, the density of the diffusion bodies 12b is set to be higher in the periphery of the first diffusion member 12 than in the center thereof.

In the light-emitting device 110 according to this embodiment, for uniformizing the brightness of the third light 11c over the X axis direction (axis direction of the first light 11a) and making the third light 11c totally have high light intensity, it is preferable that the loss is as small as possible before the first light 11a reaches the front end 12f of the first diffusion member 12 from the inlet end 12n of the first diffusion member 12.

That is, while the first light 11a proceeds through the first diffusion member 12 and reaches the front end 12f of the first diffusion member 12, it is preferable that the number of reflection and scattering is smaller. Therefore, it is preferable that the first light 11a is made to go straight with a high energy in the vicinity of the center of the light axis of the first light 11a, and the first light 11a is made to reach the front end 12f.

In this case, as illustrated in FIGS. 3A to 3D, by setting the density of the diffusion bodies 12b in the central part of the diffusion member 12 to be low and setting the density of the diffusion bodies 12b in the peripheral part to be high, the loss of the first light 11a can be suppressed.

In FIG. 5A and 5B, the relations between the density C of the diffusion bodies 12b and the distance x and between the density C and the distance y are schematically illustrated, and the relations between the density C of the diffusion bodies 12b and the distance x and between the density C and the distance y are shown as linear functions, but the invention is not limited thereto. That is, various modifications of the relations between the density C of the diffusion bodies 12b and the distance x and between the density C and the distance y like downward-convex curves, upward-convex curves, or curves having inflection points are possible.

As described later, when a semiconductor laser is used as the first laser light source, the diffusion bodies 12b may be distributed in accordance with energy density distribution and spread of the light that are special to the semiconductor laser.

### Third Embodiment

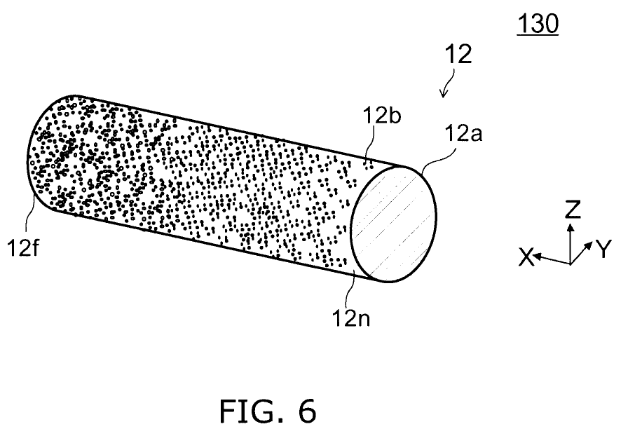

FIG. 6 is a schematic perspective view illustrating the configuration of a diffusion member used in the light-emitting device according to a third embodiment of the invention.

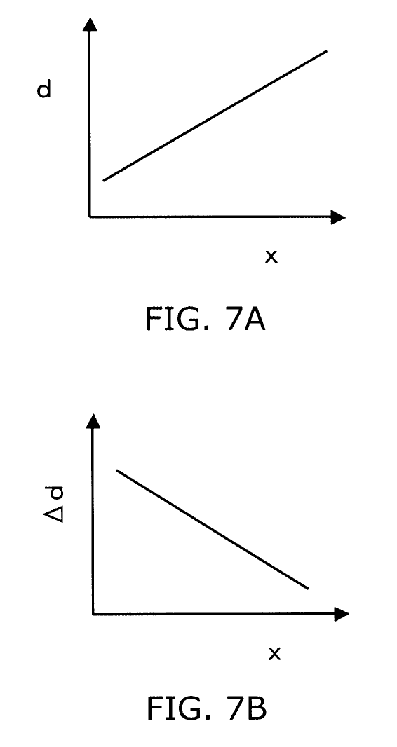

FIGS. 7A and 7B are graphic views illustrating characteristics of a diffusion member used in the light-emitting device according to the third embodiment of the invention.

That is, the horizontal axis of FIGS. 7A and 7B represents distance x in the X axis direction. And, the vertical axis of the FIG. 7A represents particle diameter d of the diffusion bodies 12b, and the vertical axis of FIG. 7B represents difference (absolute value of difference) Δd between the particle diameter d of the diffusion bodies 12b and the wavelength of the first light 11a.

The light-emitting device 130 according to the third embodiment has characteristics in the first diffusion member 12, and therefore, the first diffusion member 12 will be described.

As shown in FIG. 6, in the light-emitting device 130 according to the third embodiment of the invention, the first diffusion member 12 has, for example, the translucent columnar rod-shaped structure 12a, and the diffusion bodies 12b are provided in the rod-shaped structure 12a.

And, as shown in FIGS. 7A, the particle diameter d of the diffusion bodies 12b is larger as the distance x is larger. That is, the particle diameter of the diffusion bodies 12b is set to be larger at the front end 12f side of the first diffusion member 12 than at the inlet end 12n of the first diffusion member 12.

Other than this configuration, the light-emitting device 130 can be the same as the light-emitting device 110, and thus, the description thereof will be omitted.

Thereby, when the number density per volume of the diffusion bodies 12b is approximately the same, as illustrated in FIG. 3B previously, as the distance x is larger, the ratio of generating the second light 11b with respect to the first light 11a, namely, the diffusion degree R can be increased. Thereby, the intensity I2 of the second light 11b can be constant independently of the distance x, and as a result, the uniform emitting light (third light 11c) can be obtained.

In the above-described specific example, by setting the particle diameter d of the diffusion bodies 12b to be larger as the distance x is larger, the diffusion degree R is enlarged, but the invention is not limited thereto.

The specific example shown in FIG. 7A illustrates the case where the particle diameter of the diffusion bodies 12b is smaller than the wavelength of the first light 11a, and as the particle diameter d is larger, the particle diameter d is nearer to the wavelength of the first light 11a.

As a result, as shown in FIG. 7B, as the distance x is larger, the difference Δd between the particle diameter d of the diffusion bodies 12b and the wavelength of the first light 11a is smaller. Thereby, as the distance x is larger, the diffusion degree R can be increased.

In FIGS. 7A and 7B, the relations between the distance x and the particle diameter d of the diffusion bodies 12b and between the distance x and the difference Δd are schematically illustrated, and the relations between the distance x and the particle diameter d of the diffusion bodies 12b and between distance x and the difference Δd are shown as linear functions, but the invention is not limited thereto. That is, various modifications of the relations between the distance x and the particle diameter d of the diffusion bodies 12b and between the distance x and the difference Δd like downward-convex curves, upward-convex curves, or curves having inflection points are possible.

### Fourth Embodiment

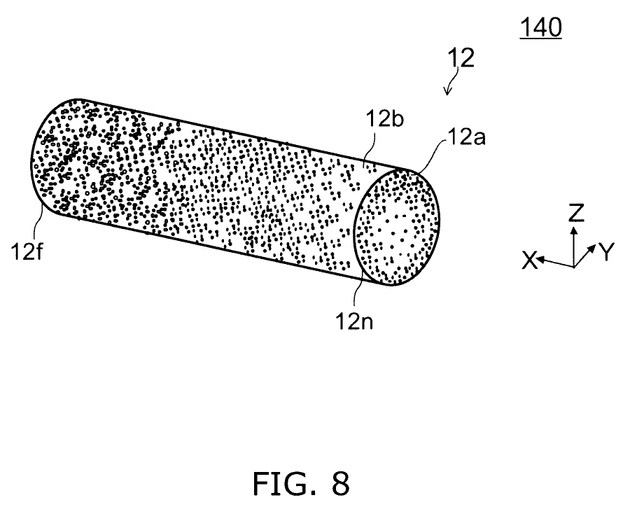

FIG. 8 is a schematic perspective view illustrating the configuration of a diffusion member used in the light-emitting device according to a fourth embodiment of the invention.

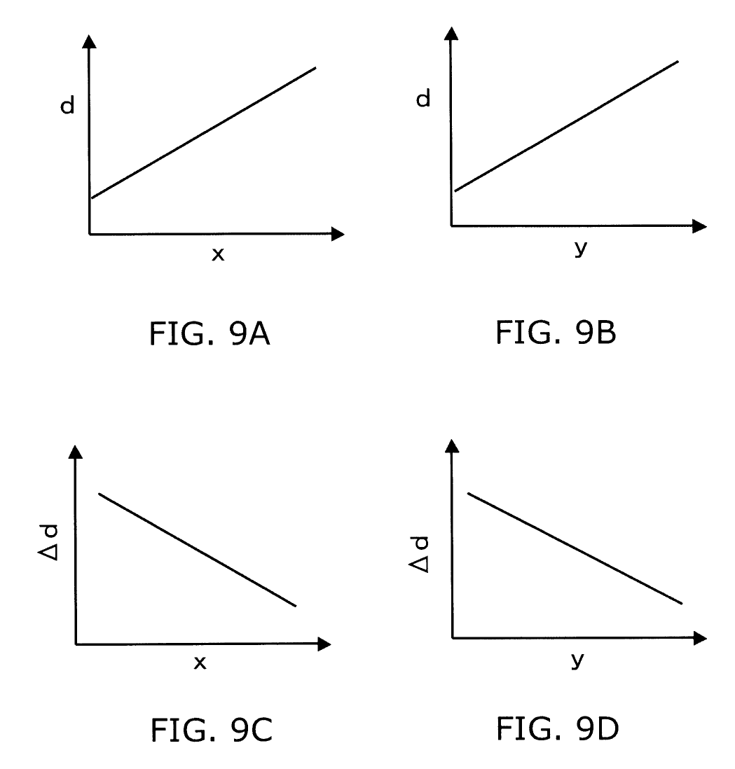

FIGS. 9A to 9D are graphs illustrating characteristics of a diffusion member used in the light-emitting device according to the fourth embodiment of the invention.

That is, the vertical axis of FIGS. 9A and 9B represents particle diameter d of the diffusion bodies 12b. And, the horizontal axis of the FIG. 9A represents distance x in the X axis direction, and the horizontal axis of FIG. 9B represents distance y in the Y axis direction. The horizontal axis of FIG. 9B may be distance z in the Z axis direction. The vertical axis of FIGS. 9C and 9D represents difference (absolute value of difference) Δd between the particle diameter d of the diffusion bodies 12b and the wavelength of the first light 11a. And, the horizontal axis of the FIG. 9C represents distance x in the X axis direction, and the horizontal axis of FIG. 9D represents distance y in the Y axis direction. The horizontal axis of FIG. 9D may be distance z in the Z axis direction.

The light-emitting device 140 according to the fourth embodiment has characteristics in the first diffusion member 12, and thus, the first diffusion member 12 will be described.

As shown in FIG. 8, in the light-emitting device 140 according to the fourth embodiment, the first diffusion member 12 has, for example, the translucent columnar rod-shaped structure 12a, and the diffusion bodies 12b are provided in the rod-shaped structure 12a.

And, as shown in FIG. 9A, the particle diameter d of the diffusion bodies 12b is larger as the distance x is large. That is, the particle diameter d of the diffusion bodies 12b is set to be larger at the front end 12f side of the first diffusion member 12 than at the inlet end 12n of the first diffusion member 12.

And, as shown in FIG. 9B, the particle diameter d of the diffusion bodies is larger as the distance y is larger. That is, the particle diameter of the diffusion bodies 12b is set to be larger in the periphery of the first diffusion member 12 than in the center thereof.

Thereby, the first light 11a is made to go straight with a high energy in the vicinity of the center of the light axis of the first light 11a, and the first light 11a is controlled to reach the front end 12f, and thereby, the loss of the first light 11a can be suppressed. Thereby, in the light-emitting device 140 according to this embodiment, the brightness of the third light 11c can be uniformized over the X axis direction (axis direction of the first light 11a) and the third light 11c can be made to totally have high light intensity,

In the above-described specific example, by setting the particle diameter d of the diffusion bodies 12b to be larger as the distance x and the distance y are larger, the diffusion degree R is enlarged, but the invention is not limited thereto.

That is, the specific examples shown in FIGS. 9A and 9B illustrate the case where the particle diameter of the diffusion bodies 12b is smaller than the wavelength of the first light 11a, and as the particle diameter d is larger, the particle diameter d is nearer to the wavelength of the first light 11a.

In this case, as shown in FIGS. 9C and 9D, as the distance x and the distance y are larger, the difference Δd between the particle diameter d of the diffusion bodies 12b and the wavelength of the first light 11a is smaller. Thereby, as the distance x is larger, the diffusion degree R can be increased.

In FIGS. 9A to 9D, the relations between the diameter d of the diffusion bodies 12b and the distance x and between the diameter d of the diffusion bodies 12b and the distance y and the relations between the difference Δd and the distance x and between the difference Δd and the distance y are schematically illustrated, and the relations between the diameter d of the diffusion bodies 12b and the distance x and between the diameter d of the diffusion bodies 12b and the distance y and the relations between the difference Δd and the distance x and between the difference Δd and the distance y are shown as linear functions, but the invention is not limited thereto. That is, various modifications of the relations between the diameter d of the diffusion bodies 12b and the distance x and between the diameter d of the diffusion bodies 12b and the distance y and the relations between the difference Δd and the distance x and between difference Δd and the distance y like downward-convex curves, upward-convex curves, or curves having inflection points are possible.

### Fifth Embodiment

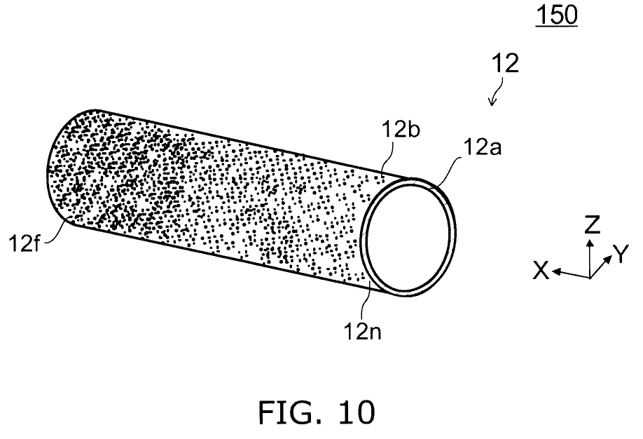

FIG. 10 is a schematic perspective view illustrating the configuration of the diffusion member used in the light-emitting device according to a fifth embodiment of the invention.

The light-emitting device 150 according to the fifth embodiment has characteristics in the first diffusion member 12, and thus, the first diffusion member 12 will be described.

As shown in FIG. 10, in the light-emitting device 150 according to the fifth embodiment, the first diffusion member 12 has, for example, a hollow cylindrical rod-shaped structure 12a, and the diffusion bodies 12b are provided in the rod-shaped structure 12a. Other than this configuration, the light-emitting device 150 can be the same as the light-emitting device 110, and thus, the description thereof will be omitted.

In this case, the thickness of the rod-shaped structure 12a is changed along the X axis direction, and thereby, the density of the diffusion bodies 12b can be changed substantially over the X axis direction. Furthermore, by the thickness of the rod-shaped structure 12a, the density of the diffusion bodies 12b can be substantially changed between the central part and the peripheral part of the first diffusion member 12.

Moreover, when the first diffusion member 12 has the cylindrical rod-shaped structure, together with the thickness of the rod-shaped structure 12a, the density of the diffusion bodies 12b disposed inside the rod-shaped structure 12a may be changed.

As described above, by the adjustment of the density of the diffusion bodies in the rod-shaped structure 12a and the adjustment of the thickness of the rod-shaped structure 12a, the ratio of the area covered with the diffusion bodies 12b with respect to the surface area of the surface of the first diffusion member 12 can be enhanced.

### Sixth Embodiment

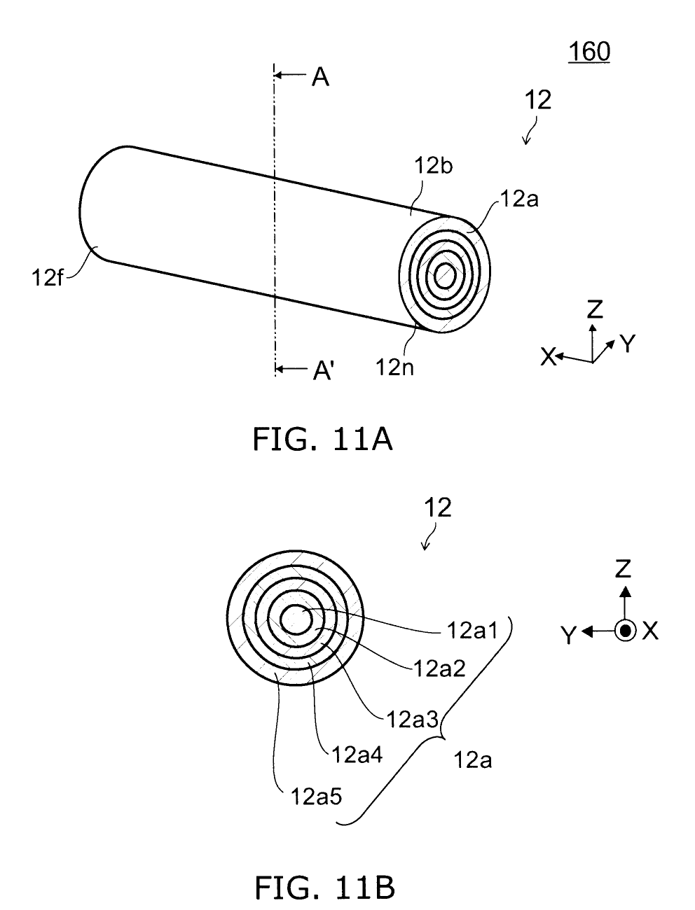

FIGS. 11A and 11B are schematic perspective views illustrating the configuration of the diffusion member used in the light-emitting device according to a sixth embodiment of the invention.

That is, FIG. 11A is the schematic perspective view, and FIG. 11B is a cross-sectional view taken along line A-A′ of FIG. 11A.

The light-emitting device 160 according to the sixth embodiment has characteristics in the first diffusion member 12, and thus, the first diffusion member 12 will be described.

As shown in FIGS. 11A and 11B, in the light-emitting device according to the sixth embodiment, for the first diffusion member 12, the rod-shaped structure 12a of glass or resin having, for example, a plurality of concentric tubes 12a1 to 12a5 is used. Other than this configuration, the light-emitting device 160 can be the same as the light-emitting device 110, and thus, the description thereof will be omitted.

And, each of the plurality of tubes 12a1 to 12a5 is provided with diffusion bodies 12b. And, in the plurality of tubes 12a1 to 12a5, for example, at least any one of density and particle diameter of the diffusion bodies 12b is changed one another, and thereby the diffusion degree can be controlled between the central part and the peripheral part of the rod-shaped structure 12a.

As described previously, along the X axis, the diffusion degree can be changed.

Thereby, the high efficient light-emitting device in which the brightness or the color is uniform over the X axis direction can be provided.

In the above description, as the first diffusion member 12, the rod-shaped structure 12a having a plurality of concentric tubes 12a1 to 12a5 is used, but onto the side surface of a thin rod-shaped structure 12a, the layers of the diffusion bodies 12b are stacked and applied with sequentially changing density or particle diameter or the like, and thereby, the first diffusion member 12 having the same effect can be obtained. In this case, for example, application can be performed with changing the density or the particle diameter or the like of the diffusion bodies 12b along the X axis direction. Also, by such a configuration, the high efficient light-emitting device in which the brightness or the color is uniform over the X axis direction can be provided.

### Seventh Embodiment

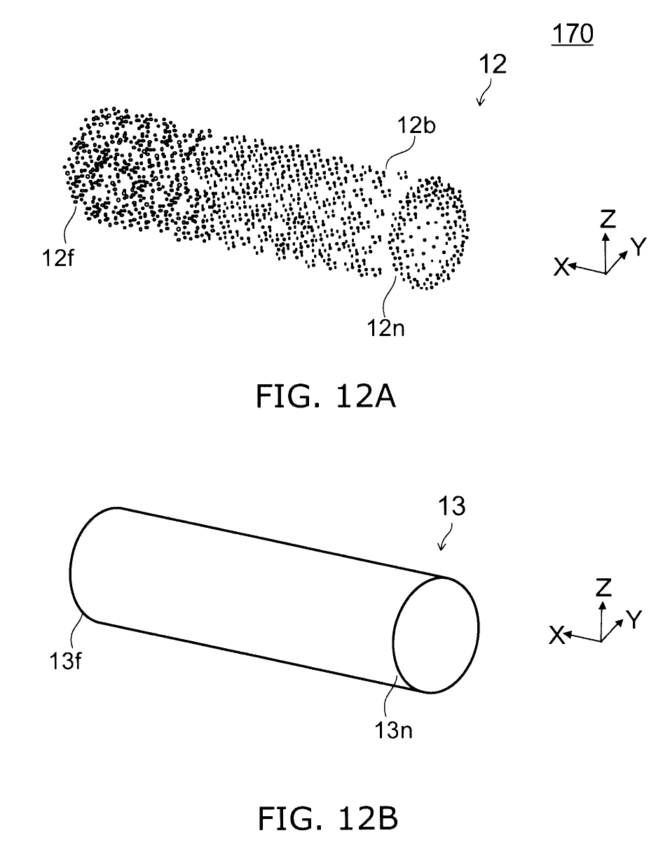

FIGS. 12A and 12B are schematic perspective views illustrating the configuration of the diffusion member and the wavelength-converter used in the light-emitting device according to a seventh embodiment of the invention.

That is, FIG. 12A illustrates the configuration of the first diffusion member 12, and FIG. 12B illustrates the configuration of the first wavelength-converter 13.

As shown in FIGS. 12A and 12B, in another light-emitting device 170 according to the seventh embodiment, the first diffusion member 12 does not have the rod-shaped structure 12a. That is, the first wavelength-converter 13 has a cylindrical shape, and inside the first wavelength-converter 13, the diffusion bodies 12b are provided.

For example, the first wavelength-converter 13 is formed from a tubular structure of glass or resin or the like containing a fluorescent material, and inside the first wavelength-converter 13, the diffusion bodies 12b are provided. For example, the diffusion bodies 12b can be provided by a method of, for example, applying micro-particles to be the diffusion bodies 12b onto the surface of an inner wall of the tubular structure of the first wavelength-converter 13.

As the first diffusion member 12, solid or liquid diffusion bodies 12b trapped in the inner spaces of the, for example, tubular structure of the first wavelength-converter 13 may be used. For example, as the first diffusion member 12, mist such as liquid trapped in the inner spaces of the, for example, tubular structure of the first wavelength-converter 13 can be used.

Moreover, as the diffusion member 12, there can be used the diffusion bodies 12b of solid or liquid or gas or the like dispersed in a medium inside the inner space of the, for example, tubular structure of the first wavelength-converter 13 in which as the medium, liquid materials such as pure water, aqueous solution, alcohol, and ionic liquid, and various gases (including gaseous substance such as nitrogen and rare gas and air) are used. For example, the structure in which bubbles are dispersed in a liquid can be used.

Furthermore, as the first diffusion member 12, the medium is not used, but the diffusion bodies 12b of solid or liquid or the like dispersed in vacuum (including various states in which the pressure is lower than the atmosphere pressure) may be used. By using the gas filled in a certain space as the first diffusion member 12 or using the vacuum of a certain space, the light transmittance can be high.

As the first diffusion member 12, for example, a sponge-formed structure provided in the inner spaces of the structures having various shapes by, for example, the first wavelength-converter 13 or the like can be used. In this case, convexoconcave in the sponge-formed structure itself may be used as the diffusion bodies 12b, or the diffusion bodies 12b of solid or liquid or the like may be further provided in the sponge-formed structure.

In using the medium of liquid as the diffusion member 12, it is particularly preferable to use the colorless and transparent liquid material such as pure water, aqueous solution, alcohol, or ionic liquid. In using the medium of liquid, the structure of the light-emitting device 110 is appropriately devised so that there is no leak and no dry up. Flowability of the medium is devised so that the distribution of the diffusion bodies 12b is held to be stable.

As described above, as the first diffusion member 12, the structure in which the diffusion bodies 12b are provided in the spaces having various shapes formed by, for example, the first wavelength-converter 13 or the like can be used. The spaces are made to contact the air as it is or insulated from the atmospheric air with various walls so as not to contact the outside for stable operation. In each of the above-described cases, particularly in using water, the configuration considering safety of the device is constructed so that short circuit and electric leak of electric wiring supplied to the first laser light source 11 or the like and of various electric system are not caused.

### Eighth Embodiment

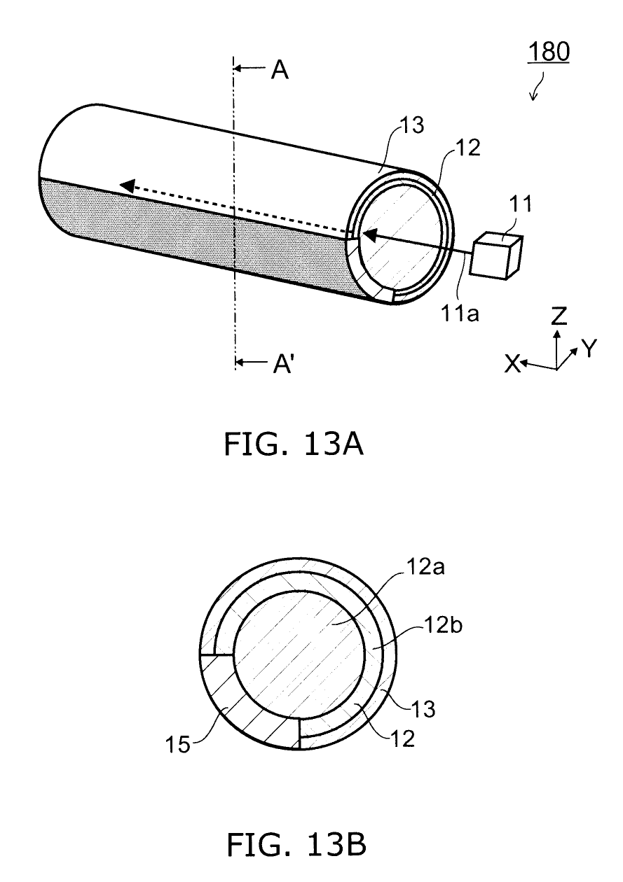

FIGS. 13A and 13B are schematic perspective views illustrating the configuration of the light-emitting device according to an eighth embodiment of the invention.

That is, FIG. 13A is a schematic perspective view, and FIG. 13B is a cross-sectional view taken along line A-A′ of FIG. 13A.

As shown in FIG. 13, in the light-emitting device 180 according to the eighth embodiment of the invention, a shield 15 is provided along the X axis direction. That is, the first diffusion member 12 has the cylindrical rod-shaped structure 12a, and the diffusion bodies 12b are provided in part of the side surface of the rod-shaped structure 12a, and in the residual part of the side surface, the shield 15 is provided. And, the first wavelength-converter 13 is provided so as to correspond to the disposition site of the diffusion bodies 12b. Other than this configuration, the light-emitting device 180 can be the same as the light-emitting device 110, and thus, the description thereof will be omitted.

For the shield 15, for example, a layer, film, and foil of metal or metal oxide having high reflectance can be used, and the shield 15 can reflect the first light 11a. The shield 15 may be set to reflect at least any one of the first light 11a, the second light 11b, and the third light 11c. By providing the shield 15, in the light-emitting device 180 according to this embodiment, it is possible that the light is not output to the needless region, and thereby, the higher efficient light-emitting device adapted into various use applications can be provided.

The above-described shield 15 may be possibly a light-absorber, and also in this case, it is possible that the light is not output to the region that is not desired.

As described above, the diffusion member 12 and the first wavelength-converter 13 are provided along the first light 11a, and not only can surround the entirety of the light flux of the first light 11a but also can be provided so that the first light 11a is facing part thereof with centering the X axis direction.

That is, not only the light can be diffused uniformly to the entire side surface of the rod-shaped structure 12a, but also the above-described shield 15 or the like can be provided so as to correspond to an uneven illumination pattern or the partial region having no light according to the specifications of the light-emitting device or the illuminating device, and thereby, the output region can be controlled.

In this case, in the region that is not provided with the shield 15, a large amount of the diffusion bodies can be disposed so as to diffuse a large amount of the light. That is, angle dependency can be provided in distribution of the diffusion bodies. Moreover, by concentrating and disposing the diffusion bodies in the part to be strongly shined, the light-emitting device or the illuminating device having a mottled distribution or a display function by light strength difference can also be produced.

### Ninth Embodiment

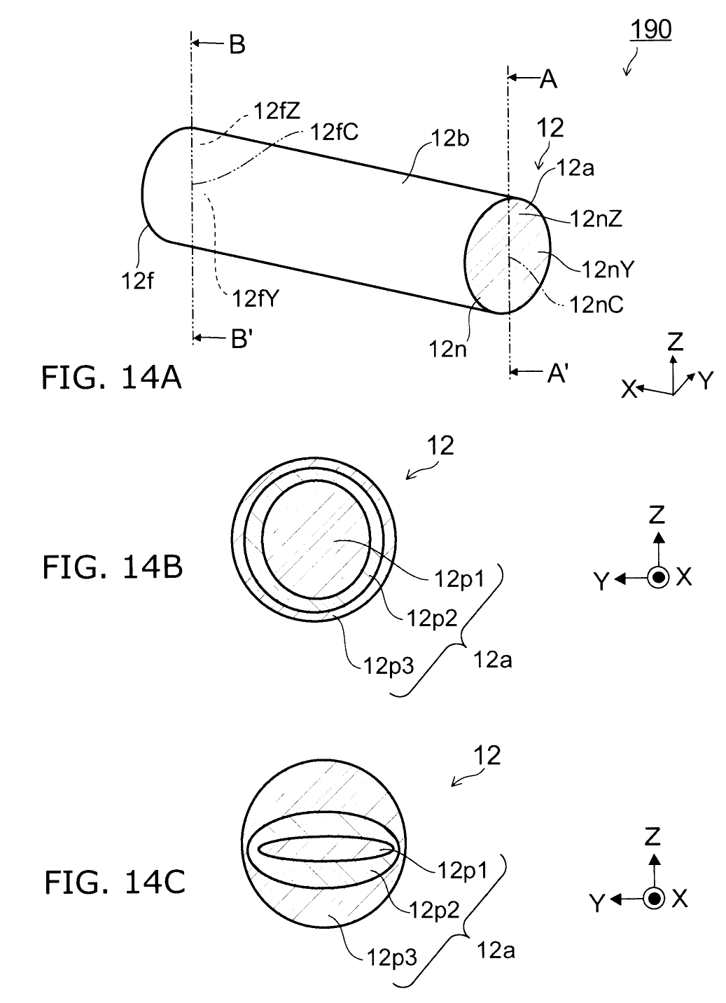

FIGS. 14A to 14C are schematic views illustrating the configuration of the light-emitting device according to a ninth embodiment of the invention.

That is, FIG. 14A is the schematic perspective view, and FIG. 14B is a cross-sectional view taken along line A-A′ of FIG. 14A, and FIG. 14C is a cross-sectional view taken along line B-B′ of FIG. 14.

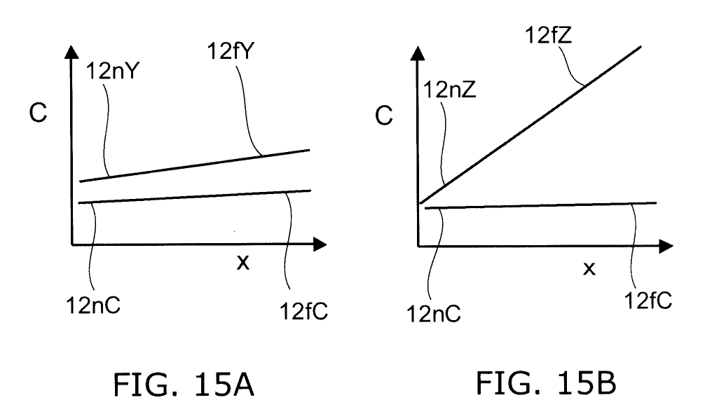

FIGS. 15A and 15B are graphs illustrating characteristics of the diffusion member used in the light-emitting device according to the ninth embodiment of the invention.

That is, FIGS. 15A and 15B illustrate density distributions of the diffusion bodies 12b of the first diffusion member 12, and the horizontal axis represents distance x in the X axis direction, and the vertical axis represents density C. And, FIG. 15A shows the distribution in the Y axis direction, and FIG. 15B shows the distribution in the Z axis direction.

In the light-emitting device 190 according to this embodiment, as the first laser light source 11, the semiconductor laser light-emitting element is provided. And, the characteristics of the first diffusion member 12 are controlled to be adapted to the characteristics of the semiconductor laser light-emitting element.

That is, as shown in FIGS. 14B and 14C, in the light-emitting device 190 according to the ninth embodiment of the invention, the distribution in the Y-Z plane of the diffusion degree in the first diffusion member 12 is changed in the X axis direction.

That is, as shown in FIG. 14B, in part of the inlet end 12n of the first diffusion member 12, from the central part to the peripheral part of the rod-shaped structure 12a, a low-density part 12p1 of the diffusion bodies 12b, a middle-density part 12p2 thereof, and a high-density part 12p3 are provided in this order, and the sectional shapes of the low-density part 12p1 and the middle-density part 12p2 are elliptical shapes each in which the Z axis direction is the long axis and the Y axis direction is the short axis. And, the ratio of the long axis to the short axis is relatively near to 1. That is, the eccentricity is small.

On the other hand, as shown in FIG. 14C, in part of the front end 12f of the first diffusion member 12, from the central part to the peripheral part of the rod-shaped structure 12a, the low-density part 12p1 of the diffusion bodies 12b, the middle-density part 12p2 thereof, and the high-density part 12p3 are provided in this order, and the sectional shapes of the low-density part 12p1 and the middle-density part 12p2 are elliptical shapes each in which the Y axis direction is the long axis and the Z axis direction is the short axis. And, the ratio of the long axis to the short axis is larger than 1, and the eccentricity is large, and the shape is considerably flat elliptical shape.

The characteristics are illustrated in FIGS. 15A and 15B.

That is, as shown in FIG. 15A, from the central part 12nC of the inlet end 12n of the first diffusion member 12 to the central part 12fC of the front end 12f of the first diffusion member 12, the density C is relatively small. And, from the peripheral part 12nY of the Y axis direction of the inlet end 12n of the first diffusion member 12 to the peripheral part 12fY of the Y axis direction of the front end 12f of the first diffusion member 12, the density C is larger than those of the central part 12nC and the central part 12fC and gradually becomes larger as the distance x becomes larger.

On the other hand, as shown in FIG. 15B, from the peripheral part 12nZ of the Z axis direction of the inlet end 12n of the first diffusion member 12 to the peripheral part 12fZ of the Z axis direction of the front end 12f of the first diffusion member 12, the density C rapidly becomes larger as the distance x becomes larger.

As described above, distribution in the Y-Z plane of the density of the diffusion bodies 12b in the first diffusion member 12 is changed in the X axis direction, and thereby, the distribution in the Y-Z plane of the diffusion degree in the first diffusion member 12 is changed in the X axis direction.

That is, in the light-emitting device 190 according to this embodiment, the distribution in the Y-Z plane of the diffusion degree in the first diffusion member 12 is changed in the X axis direction.

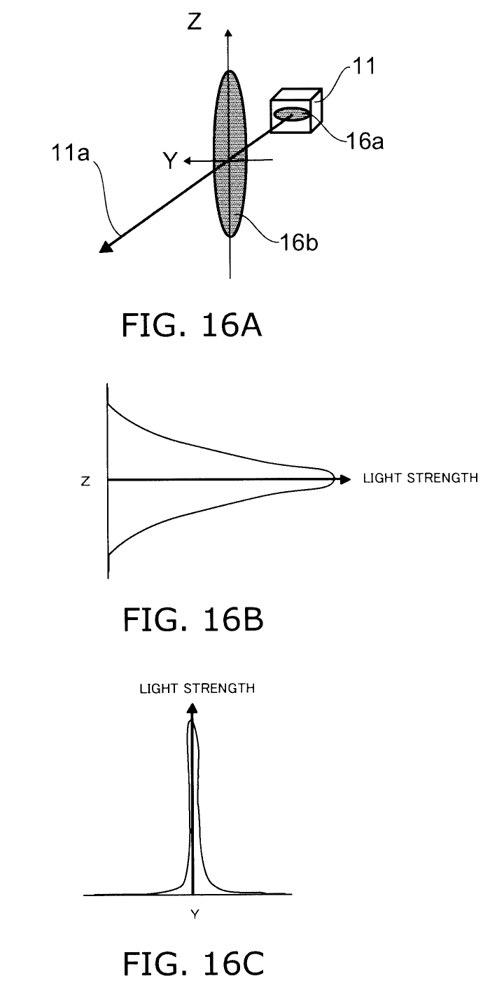

FIGS. 16A to 16C are schematic views illustrating characteristics of the light-emitting device according to the ninth embodiment of the invention.

That is, FIG. 16A illustrates a pattern of the light output from the semiconductor laser light-emitting element, and FIG. 16B illustrates the intensity distribution in the Z axis direction of the far field pattern (FFP), and FIG. 16C illustrates the intensity distribution in the Y axis direction of FFP.

As shown in FIG. 15A, in the semiconductor laser light-emitting element that is the first laser light source 11, the near field pattern (NFP) 16a and the far field pattern (FFP) 16b are different. That is, the spot shape of the first light 11a in the end face of the light-emitting layer of the semiconductor laser light-emitting element is the NFP, and in this specific example, the shape is an elliptical shape in which the Y axis direction is the long axis and the Z axis direction is the short axis. By contrast, in the FFP that is a light emission shape, the shape is an elliptical shape in which the Z axis direction is the long axis and the Y axis direction is the short axis. As described above, the NFP and the FFP having different directions by 900, and the characteristics are specific for the laser light by a semiconductor light-emitting element.

And, for example, the FFP of the first light 1la has a relatively wide intensity distribution in the Z axis direction as shown in FIG. 16B, and by contrast, has a very precipitous peak in the Y axis direction as shown in FIG. 16C.

In the light-emitting device 190 according to this embodiment, distribution in the Y-Z plane of the diffusion degree in the first diffusion member 12 is changed in the X axis direction in accordance with the characteristics of the above-described semiconductor laser light-emitting element, and thereby, the brightness distribution is uniformized around the axis centering the X axis direction. Thereby, the light-emitting device emitting white light with uniform brightness distribution and high light intensity and little unevenness of the color can be provided.

That is, in the light emitted from the semiconductor laser light-emitting element, when the light is cut by a perpendicular plane to the output direction, the sectional shape of the light flux becomes a very long and thin elliptical shape. That is, this case is different from the case of LED in which the distribution of the emitted light becomes approximately circle. Considering the difference between the light strength of the long axis direction and the short axis direction, the first diffusion member 12 is designed, and for example, the distribution of density or particle diameter or the like of the diffusion bodies 12b is optimized. That is, in the semiconductor laser light-emitting element, differently from emission of LED or the like, the energy is concentrated in the vicinity of the center of the axis of the outgoing direction. It is required to achieve such light uniformity as described above by adjusting diffusion degree in the vicinity of the center and in the weak light therearound.

Furthermore, with respect to the above-described long and thin elliptical shape, on the basis of the difference between the near field pattern (NFP) that is the spot shape of the end face of the semiconductor light-emitting layer of the output light and the far field pattern (FFP) that is the light emission shape, the first diffusion member 12 is designed, and for example, the distribution of density or particle diameter or the like of the diffusion bodies 12b is optimized.

In the above description, as a technique for changing, in the X axis direction, the distribution in the Y-Z plane of the diffusion degree in the first diffusion member 12, the case where the method of changing the density C of the diffusion bodies 12b is used has been described. However, the invention is not limited thereto, and various techniques such as a technique for changing the particle diameter of the diffusion bodies 12b, a technique for changing type of the diffusion bodies 12b to change, for example, the reflectance, and a technique for changing the thickness of the rod-shaped structure 12a, which have been described previously can be used singly or in combination.

In the above description, the method for controlling the diffusion degree of the first diffusion member 12 with corresponding to the NFP and the FFP of the first laser light source has been described, but the invention is not limited to the NFP or the FFP, and the optical characteristics such as the diffusion degree of the first diffusion member 12 can be adjusted by following the characteristics of the first light 11a radiated from the first laser light source 11, so as to compensate the characteristics.

Furthermore, the optical characteristics such as the diffusion degree of the first diffusion member 12 may be adjusted by following the characteristics of the first light 1la radiated from the first laser light source 11, so as to emphasize the characteristics. For example, the above-described elliptical shape of the FFP is used, and there can also be realized the light-emitting device in which the characteristics of the first diffusion member 12 are adjusted so that the elliptical shape is further emphasized and thereby the light strength is strengthened in the direction of the characteristics.

### Tenth Embodiment

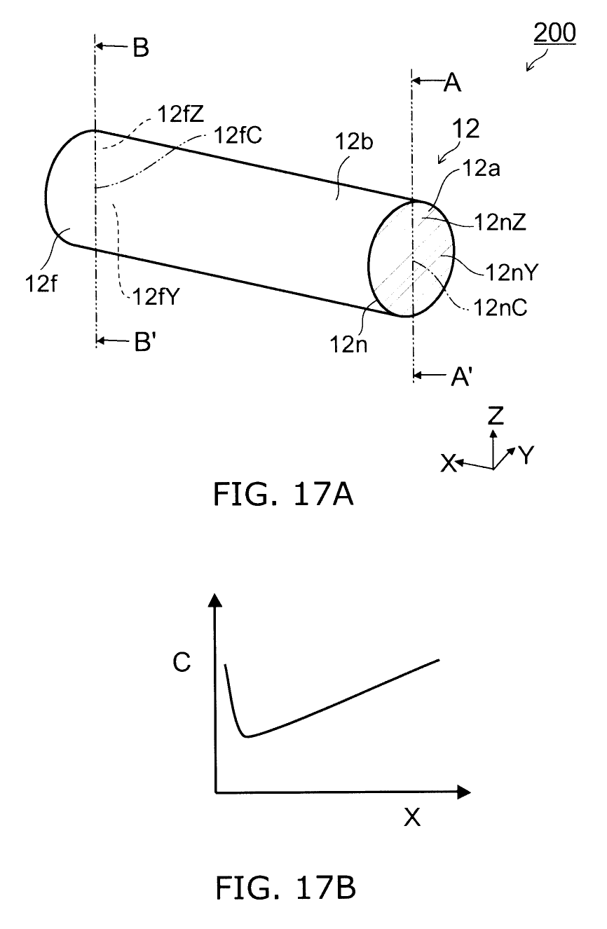

FIGS. 17A and 17B are schematic views illustrating the configuration of the diffusion member used in the light-emitting device according to a tenth embodiment of the invention.

That is, FIG. 17A is a schematic perspective view, and FIG. 17B is a graph illustrating characteristics of the first diffusion member 12 used in the light-emitting device. The horizontal axis represents distance x in X axis direction, and the vertical axis represents density C.

As shown in FIG. 17, in the light-emitting device 200 according to this embodiment, the density C is locally high in the region near to the first laser light source 11 in which the distance x is very small, and becomes low once as the distance x increases, and then increases. That is, in the characteristics of the light-emitting device 110 illustrated in FIGS. 3A to 3D, the density C is set to be high in the region in which the distance x is very small.

The laser light is coherent and has high energy density, and therefore, depending on the output power, if the light leaks out of the light-emitting device, occasionally, the light adversely affects a region such as an eye of a human.

By contrast, in the light-emitting device 200 according to this embodiment, the diffusion bodies 12b of the first diffusion member 12 are disposed so that the strong laser light does not leak from the light-emitting device 200. That is, in the vicinity of the first laser light source 11, the diffusion bodies 12b are disposed with high density.

In this case, in the vicinity of the inlet end 12n, it is preferable that the degree of diffusion of the first light 11a passing through the vicinity of the center of the axis of the first diffusion member 12 is low, and therefore, the diffusion bodies 12b can be disposed to be concentrated in the vicinity of the surface of the first diffusion member 12 so that the high-density disposition of the diffusion bodies 12b is concentrated in the peripheral part of the axis.

That is, the diffusion bodies 12b are disposed with high density in the outer part of the first diffusion member 12, in the vicinity of the inlet end 12n of the first diffusion member 12, in the region with strong energy of the first light 11a, and thereby, the reflectance is enhanced to prevent the direct projection, and the coherence can be weakened by the repetitive scattering.

Thereby, the strong laser light can be prevented from leaking out of the rod-shaped structure, and the safe light-emitting device can be provided.

### Eleventh Embodiment

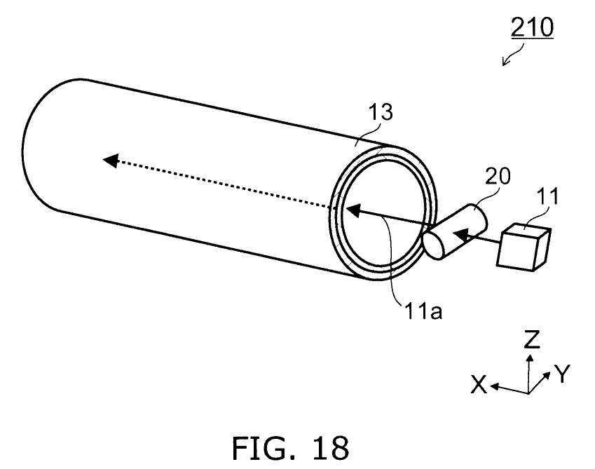

FIG. 18 is a schematic view illustrating the configuration of the light-emitting device according to an eleventh embodiment of the invention.

As shown in FIG. 18, in the light-emitting device 210 according to the eleventh embodiment of the invention, the first light 11a radiated from the first laser light source is input to the first diffusion member 12 through a lens 20. Other than this configuration, the light-emitting device 210 can be the same as the light-emitting device 110, and thus, the description thereof will be omitted.

The lens 20 is, for example, a cylindrical lens, and exerts an action of reducing the difference of the distances of the short axis direction and the long axis direction of the FFP of the first light 11a radiated from the first laser light source 11. Thereby, the light flux of the first light 11 can be formed to have a section with a circular shape from the elliptical shape.

As described above, the lens 20 for light control can be further used. The disposition of the diffusion bodies 12b in accordance with the shape of the FFP has been described previously, but because the difference between the distances of the long axis direction and the short axis direction of the FFP occasionally becomes 100-fold or more, skilled control of the diffusion bodies is required for substantially uniformly diffusing the light. In this case, by placing the appropriate lens so that the light of the long axis direction is narrowed down, the difference between the distances of the long axis direction and the short axis direction can be small, and the control can be more easily performed.

Thereby, the optical characteristics of the first diffusion member 12 can be set to be isotropic characteristics, and the design and production become easy.

This lens 20 can be provided in the light emitting-devices of all of the embodiments described previously.

For converging the spread light, for example, the lens is provided so as to correspond to the rod-shaped structure used in the first diffusion member 12, and thereby, the control can be performed so that the light passes through a long distance in the rod-shaped structure 12a, and the required part can be irradiated with a large amount of light.

### Twelfth Embodiment

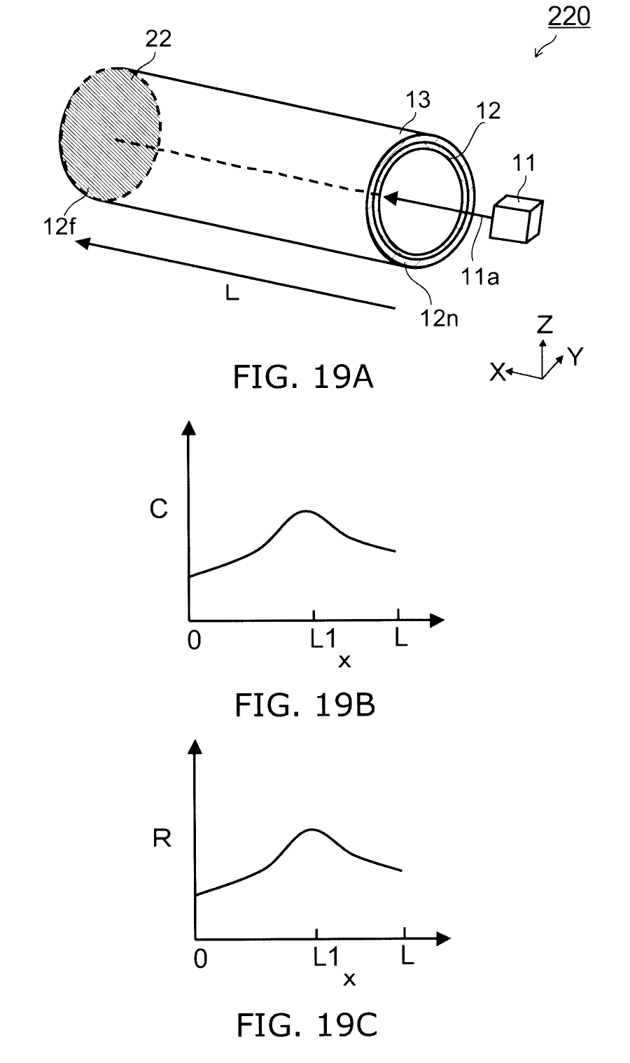

FIGS. 19A to 19C are schematic views illustrating the configuration of the light-emitting device according to a twelfth embodiment of the invention. That is, FIG. 19A illustrates the configuration of the light-emitting device, and FIG. 19B illustrates density of the diffusion bodies 12b of the first diffusion member 12 used in the light-emitting device, and the horizontal axis represents distance x in the X axis direction, and the vertical axis represents density C. FIG. 19C illustrates optical characteristics of the first diffusion member 12, and the horizontal axis represents distance x in the X axis direction, and the vertical axis represents diffusion degree R.

As shown in FIG. 19A, the light-emitting device according to the twelfth embodiment of the invention has the configuration in which a reflector 22 (reflection member) is provided in the front end 12f of the first diffusion member 12 in the light-emitting device 110. Other than this configuration, the light-emitting device 220 can be the same as the light-emitting device 110, and thus, the description thereof will be omitted.

For the reflector 22, for example, metal or metal oxide having high reflectance can be used, and the reflector 22 can reflect the first light 11a (and the second light 11b).

The reflector 22 may reflect at least any one of the first light 11a, the second light 11b, and the third light 11c. By providing the reflector 22, the first light 11a (and the second light 11b) reaching the front end 22f of the first diffusion member 12 can be returned to the first diffusion member 12 again, and thereby the efficiency is improved.

In this case, as shown in FIG. 19B, in the first diffusion member 12, as the distance x increases, the density C of the diffusion body 12b increases, and then decreases. That is, because the first light 11a (and the second light 11b) is returned to the first diffusion member 12 again by the reflector 22 near the front end 12f of the first diffusion member 12, the brightness of the first light 11a (and the second light 11b) is high. Corresponding to this characteristic, the density C of the diffusion bodies 12b is adjusted.

For example, when the length (length in the X axis direction) of the first diffusion member 12 is L, the density C is made to have the local maximum at the length of L1. The length of L1 is, for example, larger than ½ of the length L and smaller than L.

Thereby, as shown in FIG. 19C, as the distance x increases, the diffusion degree R of the first diffusion member 12 increases, and then decreases. For example, the diffusion degree R has the local maximum at the length of L1. That is, corresponding to the characteristic that the brightness of the first light 11a (and the second light 11b) becomes high near the front end 12f of the first diffusion member 12, the diffusion degree R of the first diffusion member 12 is adjusted.

Thereby, the brightness of the third light 11c can be uniform along the X axis direction.

In the light-emitting device 220 according to this embodiment, the light-emitting device emitting white light with high efficiency, uniform brightness distribution, high light intensity and little unevenness of the color can be provided.

Also, in the light-emitting device 220 according to this embodiment, in the first diffusion member 12, the ratio (such as diffusion degree R) of generating the second light 11b from the first light 11a is set to be higher in a far position from the first laser light source than in a near position thereto. That is, when the distance x is the length L1 or less, the diffusion degree R increases as the distance x increases.

And, when the distance x is larger than L1, the diffusion degree R decreases as the distance x increases.

That is, in the first diffusion member 12, the ratio (such as diffusion degree R) of generating the second light 11b from the first light 1la is set to be higher in a part in which brightness of the first light 11a radiated from the first laser light source 11 is high than in a part in which the brightness is low.

In this specific example, for adjusting the diffusion degree R of the first diffusion member 12, the density C of the diffusion bodies 12b is changed, but the invention is not limited thereto. And, various techniques such as a technique for changing the particle diameter of the diffusion bodies 12b, a technique for changing type of the diffusion bodies 12b to change, for example, the reflectance, and a technique for changing the thickness of the rod-shaped structure 12a, which have been described previously can be used singly or in combination.

Moreover, this specific example can be used together with the technique of locally enhancing density of the diffusion bodies 12b in the vicinity of the inlet end 12n to prevent the strong laser light from leaking out of the first diffusion member which has been described previously.

Moreover, the above-described reflector 22 can be provided in the light-emitting devices of all of the embodiments described previously. The characteristics of the first diffusion member 12 of this case can be the same characteristics as described in this embodiment.

### Thirteenth Embodiment

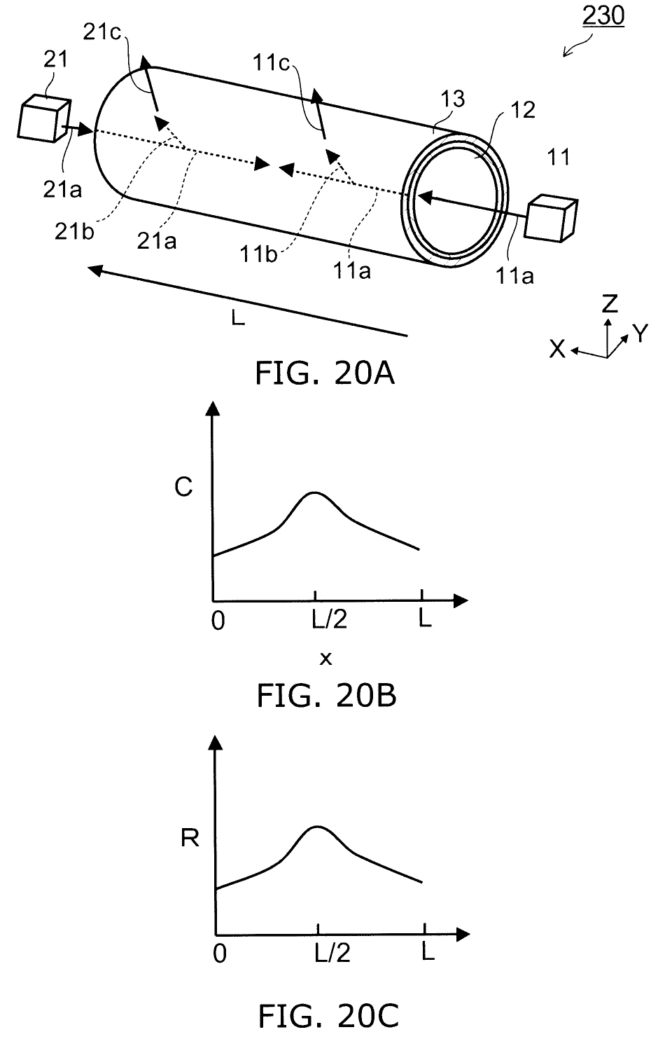

FIGS. 20A to 20C are schematic views illustrating the configuration of the light-emitting device according to a thirteenth embodiment of the invention. That is, FIG. 20A illustrates the configuration of the light-emitting device, and FIG. 20B illustrates density of the diffusion bodies 12b of the first diffusion member 12 used in the light-emitting device, and the horizontal axis represents distance x in the X axis direction, and the vertical axis represents density C. FIG. 20C illustrates optical characteristics of the first diffusion member 12, and the horizontal axis represents distance x in the X axis direction, and the vertical axis represents diffusion degree R.

As shown in FIG. 20A, in the light-emitting device 230 according to the thirteenth embodiment of the invention, laser light sources are provided at both ends of the first diffusion member 12 in the light-emitting device 110. That is, in addition of the previously described first laser light source 11, a second laser light source 21 is provided in the end opposite to the end of the side provided with the first laser source 11. Other than this configuration, the light-emitting device 230 can be the same as the light-emitting device 110, and thus, the description thereof will be omitted.

That is, the light-emitting device 230 according to this embodiment further includes the second laser light source 21 that is provided in a side opposite to the side provided with the first laser light source 11 of the first diffusion member 12 and that radiates a seventh light 21a, the first diffusion member 12 generates, from the seventh light 21a, an eighth light 21b outgoing in different directions from the light axis direction of the seventh light 21a, a ratio of generating the eighth light 21b from the seventh light 21a is higher in a part in which intensity of the seventh light 21a is low than in a part in which the intensity is high, and the wavelength-converter 13 absorbs the eighth light 21b and emits a ninth light 21c having different wavelength from the eighth light 21b.

For the second laser light source 21, the same light source as the first laser light source 11 can be used. However, the invention is not limited thereto, but the second laser light source 21 may have different specifications from the first laser light source 11. Hereinafter, the case in which the second laser light source 21 has the same specifications as the first laser light source 11 will be described.

As described above, by disposing the first laser light source 11 and the second laser light source 21 in the both ends of the first diffusion member 12, the more uniform emitted light can be obtained.

In this case, because the light (the first light 11a, the seventh light 21a) are input to the first diffusion member 12 from the both ends, the light has the characteristics that the intensity of the light (the first light 11a, the seventh light 21a) becomes attenuated from the both ends to the central part.

Therefore, as shown in FIG. 20B, in the first diffusion member 12, as the distance x increases, the density C of the diffusion bodies increases, and then decreases. That is, when the length (length in the X axis direction) of the first diffusion member 12 is L, the density C is made to have the local maximum at the length of L/2.

Thereby, as shown in FIG. 20, as the distance x increases, a ratio of generating the second light 11b (eighth light 21b) with respect to the first light 1la (and seventh light 21a), namely, the diffusion degree R of the first diffusion member 12 increases, and then decreases. That is, the diffusion degree R has the local maximum at the length of L/2.

Thereby, brightness of the third light 11c and the ninth light 21c can be uniform along the X axis direction.

According to the light-emitting device 230 according to this embodiment, the light-emitting device emitting white light with high efficiency, uniform brightness distribution, high light intensity and little unevenness of the color can be provided.

Also, in the light-emitting device 230 according to this embodiment, in the first diffusion member 12, the ratio (such as diffusion degree R) of generating the second light 11b from the first light 11a is set to be higher at a far position from the first laser light source than at a near position thereto. That is, when the distance x is set to be the distance from the side of the first laser light source 11, and is the length of L/2 or less, as the distance x increases, the diffusion degree R increases. On the other hand, when the distance x is set to be the distance from the side of the second laser light source 21, and is the length of L/2 or less, as the distance x increases, the diffusion degree R increases.

That is, in the first diffusion member 12, the ratio (such as diffusion degree R) of generating the second light 11b from the first light 11a and the ratio (such as diffusion degree R) of generating the eighth light 21b from the seventh light 21a are set to be higher in the part with high brightness of the first light 11a and the seventh light 21a radiated from the first and second laser light sources 11, 12 than in the part with the low brightness.

In this specific example, for adjusting the diffusion degree R of the first diffusion member 12, the density C of the diffusion bodies 12b is changed, but the invention is not limited thereto. And, various techniques such as a technique for changing the particle diameter of the diffusion bodies 12b, a technique for changing type of the diffusion bodies 12b to change, for example, the reflectance, and a technique for changing the thickness of the rod-shaped structure 12a, which have been described previously can be used singly or in combination.

Moreover, this specific example can be used together with the technique of locally enhancing density of the diffusion bodies 12b in the vicinity of the inlet end 12n to prevent the strong laser light from leaking out of the first diffusion member which has been described previously.

Moreover, the above-described second laser light source can be provided in the light-emitting devices of all of the embodiments described previously. The characteristics of the first diffusion member 12 of this case can be the same characteristics as described in this embodiment.

### Fourteenth Embodiment

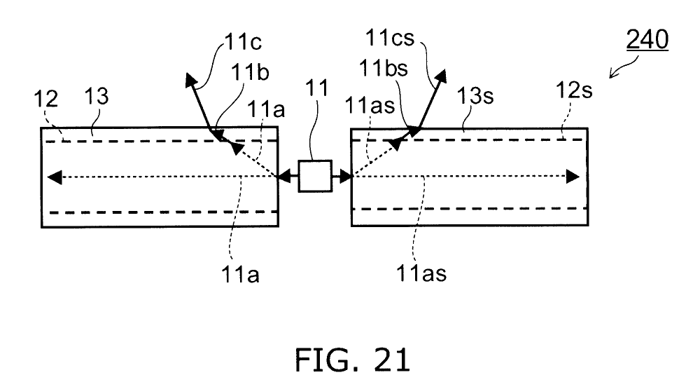

FIG. 21 is a schematic plan view illustrating the configuration of the light-emitting device according to a fourteenth embodiment of the invention.

As shown in FIG. 21, in the light-emitting device 240 according to the fourteenth embodiment of the invention, with respect to one first laser light source, two diffusion members (first diffusion member 12 and second diffusion member 12s) and two wavelength-converter (first wavelength-converter 13 and second wavelength-converter 13s) are provided. For the first laser light source 11, the first diffusion member 12, and first wavelength-converter 13, ones having the same various configurations as described previously can be used, and thus, the description thereof will be omitted.

That is, the light-emitting device 240 according to this embodiment includes the second diffusion member 12s that is provided along a light axis of a fourth light 11as radiated from the first laser light source 11 in a different direction from the first light 11a and that generates, from the fourth light 11as, a fifth light 11bs outgoing in different directions from the light axis direction of the fourth light 11as, in which a ratio of generating the fifth light 11bs from the fourth 11as is higher in a part in which intensity of the fourth light 11as is low than in a part in which the intensity is high, and a second wavelength-converter 13s provided along the second diffusion member 12s and absorbing the fifth light 11bs and emitting a sixth light 11cs having different wavelength from the fifth light 11bs.

For the second diffusion member 12s and the second wavelength-converter 13s, the same ones as the first diffusion member 12 and the first wavelength-converter 13, which are described previously, can be used.

In the case of using a semiconductor laser light-emitting element for the first laser light source 11, the light (first light 11a and fourth light 11as) is output from both end faces of the semiconductor laser light-emitting element. The two kinds of light are input to two diffusion members (first diffusion member 12 and second diffusion member 12s), and by the two wavelength-converters (first wavelength-converter 13 and second wavelength-converter 13s), the third light 11c and the sixth light 11cs can be obtained. Thereby, high efficient light-emitting device can be obtained.

The configuration of the light-emitting device 240 according to this embodiment can be applied to various configurations of the embodiments described previously. For example, the reflectors 22 can be provided in the front ends 12f of the first and second diffusion members 12, 12s, respectively. Moreover, for the first and second diffusion members 12, 12s, the diffusion members having various characteristics described previously can be adopted.

### Fifteenth Embodiment

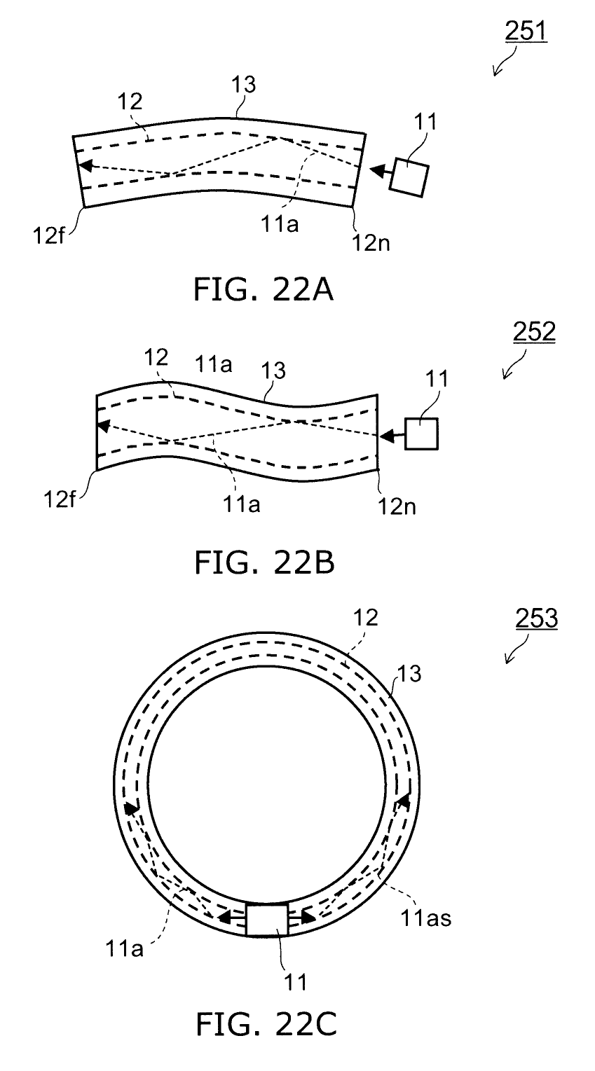

FIGS. 22A to 22C are schematic plan views illustrating the configuration of the light-emitting device according to a fifteenth embodiment of the invention.

As shown in FIG. 22A, in the light-emitting device 251 according to this embodiment, the axis of the first diffusion member 12 has a curve shape. That is, in this specific example, the first diffusion member 12 has a columnar shape curving in a circular arc shape. And, around the side surface of the columnar shape, the first wavelength-converter 13 is provided, and the first laser light source 11 is provided to be facing the inlet end 12n that is one end face of the columnar shape. The first light 1la output from the first laser light source 11 transmits the first diffusion member 12 with being reflected by the first diffusion member 12, and thereby, reaches the front end 12f of the first diffusion member 12. And, the second light 11b is generated by the first diffusion member 12, and the third light 11c is generated by the first wavelength-converter 13. As described above, the shape of the first diffusion member 12 is not limited to the shape having a linear axis, and the shape having a curved axis is also possible.

As shown in FIG. 22B, in another light-emitting device 252 according to this embodiment, the first diffusion member 12 has a columnar shape whose axis curving in a wave shape. And, around the side surface of the columnar shape, the first wavelength-converter 13 is provided, and the first laser light source 11 is provided to be facing the inlet end 12n that is one end face of the columnar shape. Also, in this case, the first light 11a output from the first laser light source 11 transmits the first diffusion member 12 with being reflected by the first diffusion member 12, and thereby, reaches the front end 12f of the first diffusion member 12. And, the second light 11b is generated by the first diffusion member 12, and the third light 11c is generated by the first wavelength-converter 13. As described above, the shape of the first diffusion member 12 can have an optional curved shape such as a wave shape.

In the invention, the above-described columnar shape is not limited to a strict column, but even if the thickness of the rod becomes thick or thin on the way, the brightness of the surface can be controlled by adjusting the diffusion degree R.

As shown in FIG. 22C, in another light-emitting device 253 according to this embodiment, the first diffusion member 12 has a shape of part of an annular shape. And, around the side surface of the annular shape, the first wavelength-converter 13 is provided, and the first laser light source 11 is provided between two end faces of the annular shape. And, the light (first light 11a and fourth light 11as) is output from the first laser light source 11 in two directions, and each of the two kinds of light (first light 11a and fourth light 11as) are input to the first diffusion member 12 from the two end faces of the first diffusion member 12. Also, in this case, the first light 11a outgoing from the first laser light source 11 transmits the first diffusion member 12 with being reflected by the first diffusion member 12, and thereby, reaches the front end 12f of the first diffusion member 12. And, the second light 11b and the fifth light 11bs are generated by the first diffusion member 12, and the third light 11c and the sixth light 11cs are generated by the first wavelength-converter 13. As described above, the shape of the first diffusion member 12 can be part of a closed shape such as an annular shape.

As described above, the shape of the first diffusion member 12 is optional.

Also, in the above-described cases of the light-emitting devices 251, 252, and 253, the first diffusion member 12 is provided along the light axis of the first light 11a outgoing from the first laser light source 11. That is, along the extending direction of the first diffusion member 12, the first light 11a proceeds, and in each part of the first diffusion member 12, the first light 1la proceeds with curving the light axis with being reflected. And, the first diffusion member 12 generates the second light 11b (and fifth light 11bs) outgoing in different directions from the light axis direction of the first light 11a (and fourth light 11as), in each of parts of the first diffusion member 12.

In the above-described light-emitting devices 251, 252, in the end facing the end provided with the first laser light source 11 of the first diffusion member 12, the previously described reflector 22 may be provided.

As described above, by the above-described light-emitting devices according to the embodiments of the invention, there can be provided the light-emitting device in which particularly a semiconductor laser light-emitting element is used as the light source and which has a fiber shape, a linear shape, or a rod shape as represented by the shape of a straight pipe fluorescent lamp or a cold cathode tube and which has high light intensity and can suppress unevenness of the color and can emit white light. And, this light-emitting device can be applied to various illuminating devices.

### Sixteenth Embodiment

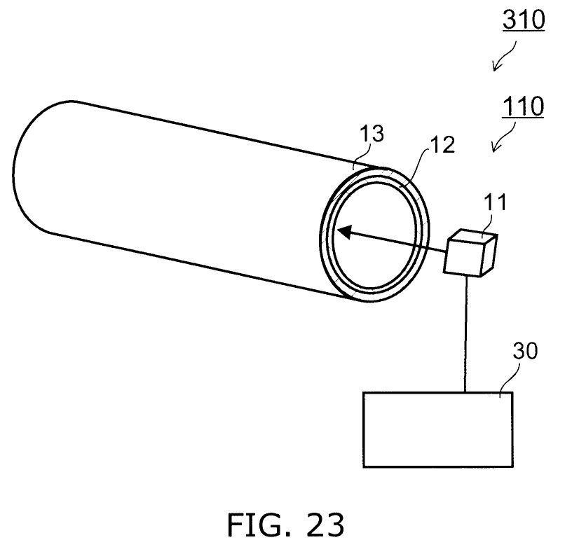

FIG. 23 is a schematic view illustrating the configuration of the illuminating device according to a sixteenth embodiment of the invention.

As shown in FIG. 23, the illuminating device 310 according to the sixteenth embodiment of the invention includes the above-described light-emitting device 110 and a current-supplier 30 for supplying a current to the first laser light source 11 of the light-emitting device 110.

Thereby, the illuminating device that has high light intensity and can suppress unevenness of the color and can emit white light can be realized.

In this specific example, the case of using the light-emitting device 110 according to the first embodiment as the light-emitting device is illustrated, but the invention is not limited thereto, but the light-emitting device according to all of the embodiments described above can be used.

When the light-emitting device has a plurality of laser light sources (for example, first laser light source 11 and second laser light source 21), the current-supplier 30 of the illuminating device 310 can supply a current to each of the plurality of laser light sources.

As described above, the embodiments of the invention have been described with reference to specific examples. However, the invention is not limited to the specific examples. For example, the specific configuration of each of the components constituting the light-emitting device and the illuminating device is included in the scope of the invention, as long as the invention can be carried out by appropriate selection from the publicly known range by those skilled in the art and the same effect can be obtained.

Moreover, combination of two or more components of the respective specific examples in the technically possible range is included in the scope of the invention as long as including the spirit of the invention.

In addition, all of the light-emitting devices and the illuminating devices that can be carried out with appropriately design-modified by those skilled in the art on the basis of the light-emitting devices and the illuminating devices described above as the embodiments of the invention belong to the scope of the invention as long as including the spirit of the invention.

In addition, it is understood that those skilled in the art can achieve various variations and modified examples and that the variations and the modified examples belong to the scope of the invention.

1. A light-emitting device comprising:
a first laser light source radiating a first light having a light axis;
a first diffusion member provided along the light axis of the first light, the first diffusion member receiving the first light and generating a second light from the first light, the second light outgoing in a direction different from a direction of the light axis of the first light, the first diffusion member having a first part and a second part, an intensity of the first light in the first part being lower than that in the second part, a ratio of generating the second light from the first light in the first part being higher than that in the second part; and
a first wavelength converter provided along the first diffusion member, the first wavelength converter absorbing the second light and emitting a third light having a different wavelength from the second light.

2. The device according to claim 1, wherein the first diffusion member is provided around the light axis of the first light.

3. The device according to claim 1, wherein in the first diffusion member, the ratio is higher in a far position from the first laser light source than in a near position thereto.

4. The device according to claim 1, wherein in the first diffusion member, the ratio is higher in a peripheral part that is far from the center of the light axis of the first light than in a central part near to the center.

5. The device according to claim 1, wherein the first diffusion member has diffusion bodies provided along the light axis of the first light.

6. The device according to claim 5, wherein density of the diffusion bodies is higher in a far side from the laser light source than in a near side thereto.

7. The device according to claim 5, wherein a diameter of the diffusion bodies is larger in a far side from the laser light source than in a near side thereto.

8. The device according to claim 5, wherein density of the diffusion bodies is locally high in a peripheral part of the first diffusion member in an inlet end of the first diffusion member facing the first laser light source.

9. The device according to claim 1, wherein an emission wavelength of the first laser light source has a peak at an emission wavelength in 380 nm to 480 nm.

10. The device according to claim 1, wherein light intensity of 350 nm or less of the first light is substantially zero.

11. The device according to claim 1, further comprising:
a lens being configured to adjust a sectional shape of a light flux of the first light in the light axis direction, the lens provided between the first laser light source and the first diffusion member.

12. The device according to claim 1, wherein the first laser light source is a semiconductor laser light emitting element.

13. The device according to claim 12, wherein in the first diffusion member, the ratio is low in a region in which light strength of a far field pattern of the semiconductor laser light-emitting element is high.

14. The device according to claim 12, wherein the first diffusion member has diffusion bodies provided along the light axis of the first light, and density of the diffusion bodies is low in a region in which light strength of the far field pattern of the semiconductor laser light-emitting element is high.

15. The device according to claim 12, further comprising:
a lens being configured to adjust a sectional shape of a light flux of the first light in the light axis direction, the lens provided between the first laser light source and the first diffusion member, the lens reducing difference between light strength in a long axis direction and light strength in a short axis direction of the far field pattern of the semiconductor laser light-emitting element.

16. The device according to claim 1, wherein the first wavelength converter has a first fluorescent material absorbing the second light and emitting light having a first wavelength different from the second light and a second fluorescent material absorbing the second light and emitting light having a second wavelength different from the second light and from the first wavelength.

17. The device according to claim 1, further comprising:
a reflection member provided on a side opposite to a side provided with the first laser light source of the first diffusion member and reflecting the first light.

18. The device according to claim 1, further comprising:
a second diffusion member provided along a light axis of a fourth light radiated from the first laser light source in a direction different from the direction of the first light, the second diffusion member receiving the fourth light and generating a fifth light from the fourth light, the fifth light outgoing in a direction different from a direction of the light axis direction of the fourth light, the second diffusion member having a third part and a fourth part, an intensity of the fourth light in the third part being lower than that in the fourth part, a ratio of generating the fifth light from the fourth light in the third part being higher than that in the fourth part; and
a second wavelength converter provided along the second diffusion member, the second wavelength converter absorbing the fifth light and emitting a sixth light having a different wavelength from the fifth light.

19. The device according to claim 1, further comprising:
a second laser light source provided on a side opposite to a side provided with the first laser light source of the first diffusion member and radiating a seventh light,
the first diffusion member receiving the seventh light and generating an eighth light from the seventh light, the eighth light outgoing in a direction different from a direction of a light axis direction of the seventh light, the first diffusion member having a fifth part and a sixth part, an intensity of the seventh light in the fifth part being lower than that in the sixth part, a ratio of generating the eighth light from the seventh light in the fifth part being higher than that in the sixth part, and
the first wavelength converter absorbing the eighth light and emitting a ninth light having a different wavelength from the eighth light.

20. An illuminating device comprising:
a light-emitting device including: a first laser light source radiating a first light having a light axis; a first diffusion member provided along the light axis of the first light, the first diffusion member receiving the first light and generating a second light from the first light, the second light outgoing in a different direction from a direction of the light axis of the first light, the first diffusion member having a first part and a second part, an intensity of the first light in the first part being lower than that in the second part, a ratio of generating the second light from the first light in the first part being higher than that in the second part; and a first wavelength converter provided along the first diffusion member, the first wavelength converter absorbing the second light and emitting a third light having a different wavelength from the second light; and
a current supplier being configured to supply a current to the first laser light source of the light-emitting device.
